(19) United States
(12) Patent Application Publication
(10) Pub. No.: US 2026/0343620 A1
(43) Pub. Date: Oct. 29, 2026

(54) SYSTEMS AND METHODS FOR RANDOM ACCESS PROCEDURE

(71) Applicant: InterDigital Patent Holdings, Inc., Wilmington, DE (US)

(72) Inventors: Nazli Khan Beigi, Longueuil (CA); Paul Marinier, Brossard (CA); Ghyslain Pelletier, Montreal (CA); Moon IL Lee, Melville, NY (US); Tao Deng, New York, NY (US); Jonghyun Park, Syosset, NY (US); Aata El Hamss, Laval (CA)

(73) Assignee: InterDigital Patent Holdings, Inc., Wilmington, DE (US)

(21) Appl. No.: 19/193,596

(22) Filed: Apr. 29, 2025

(51) Int. Cl. H04W 74/0833

(52) U.S. Cl. CPC H04W 74/0833

(57) ABSTRACT

Systems and methods for selecting Random Access Channel (RACH) Occasions for Physical Random-Access Channel (PRACH) preamble transmission during initial access procedures are disclosed. A WTRU is configured with a reference signal block, where the reference signal block includes a first reference signal with a first beam direction (e.g., wide beam) and a second reference signal with a second beam direction (e.g., differential and/or narrow beam). The WTRU selects to use the first reference signal or the second reference signal based on one or modes of operation the WTRU is configured with (e.g., uplink/downlink decoupling, service/device type, reference signal burst type, and/or coverage). The WTRU selects the RACH Occasion for PRACH preamble transmission based on the selected reference signal.

### BACKGROUND

In New Radio (NR) wireless systems, a wireless transmit/receive unit (WTRU) may determine, be configured, and/or indicated to receive, measure, and/or detect one or more reference signals (RS) (e.g., Synchronization Signal Blocks (SSBs)) from one or more cells. The WTRU may select a cell and select at least one RS (e.g., SSB) from the selected cell based on the detected, measured, and/or received SSBs. The WTRU may determine to perform the random access procedure based on at least one of the selected RSs (e.g., SSB). For example, the WTRU may transmit Physical Random Access Channel (PRACH), Msg 1, Msg 3, MsgA, etc., or receive Random Access Response (RAR), and further signaling as part of the random access procedure. In an example, the WTRU may perform random access (RA) procedure as part of initial access procedure, beam failure recovery, and so forth. In another example, the WTRU may initiate a random access procedure based on at least one received physical downlink control channel (PDDCH) order, where the WTRU may receive configuration information and/or indications on Transmission Configuration Indicator (TCI)-state, PRACH preamble, Random Access Channel (RACH) resources, etc.

An RS block includes one or more RSs in time and frequency resources, where the RSs included in an RS block may be multiplexed in time in a preconfigured and/or configured order. The RS blocks can be transmitted as part of one or more RS bursts. One example of RS blocks is SSBs that are transmitted in an SSB burst. The RSs in an RS block may be associated (e.g., in spatial domain) and/or bundled.

An SSB block may include at least one of the following: Primary Synchronization Signal (PSS), Secondary Synchronization Signal (SSS), PBCH (e.g., Data, Master Information Block (MIB)) and PBCH Demodulation Reference Signal (DM-RS). The SSBs may be transmitted by the network node (e.g. base station, transmit/receive point (TRP), relay node, reconfigurable intelligent surfaces (RIS) unit) in different beam directions. The number of SSB beams in an SSB burst set, which may be transmitted periodically within an interval (e.g. 5ms) may depend on the carrier frequency. For example, an SSB burst may contain 4 SSBs (e.g., in FR 1 for <3GHz), 8 SSBs (e.g., in FR 1, for 3 to 6GHz), 64 SSBs (e.g., for FR 2), and so forth. There may be different types of SSB bursts such as normal always-on (AO) SSB bursts, energy saving (ES) SSB bursts, on-demand (OD) SSB bursts, one-shot SSB bursts, etc. The different types of SSB bursts may possibly include a subset of SSBs in a burst, that may be transmitted aperiodically, semi-persistently, or periodically with certain periodicity.

Unlike the conventional systems, a special case of access is considered in network configurations, where the uplink and downlink transmissions may be decoupled. That is, for example, instead of connecting to the same network node (e.g., base station, NodeB, gNB, TRP, etc.) for the uplink (UL) and downlink (DL), the WTRU may be connected to two network nodes for simultaneous UL and DL transmissions. The UL/DL decoupling could be advantageous in providing scheduling flexibility, capacity enhancement, network energy saving, etc. In an example, the UL/DL decoupling could be based on using a first carrier for the DL and a second carrier for the UL, or more generally, it may be based on one or more DL-carriers in a first Bandwidth Part (BWP) and one or more UL-carriers in a second BWP. In another example, the UL/DL decoupling could be based on UL/DL decoupling in spatial domain, that is using a first TRP only for UL and a second TRP only for DL, and so forth. In another example, the UL/DL decoupling could be in cell level, that is considering UL-only cell, DL-only cell, etc.

Decoupled operation may be similar to operation without beam correspondence. With decoupled operation, a DL beam or Beam Pathloss (BPL) may be received from one TRP and an UL beam or BPL (e.g., the corresponding UL beam or BPL) may be transmitted to another TRP. Use of a pathloss (PL) measurement for a DL beam or BPL from a first TRP may not be sufficient as an estimate of the pathloss for an UL beam or BPL to a second TRP, for example to use for power control in the second TRP.

### SUMMARY

An example wireless transmit/receive unit (WTRU) is disclosed that includes a processor. The processor is configured to receive a first reference signal and a second reference signal, where the first reference signal and the second reference signal are associated, and the first reference signal is associated with a first beam direction and the second reference signal is associated with a second beam direction. The processor is further configured to receive a first Random Access Channel (RACH) configuration associated with the first reference signal and a first set of RACH occasions, and a second RACH configuration associated with the second reference signal and a second set of RACH occasions. The processor is further configured to select a RACH occasion for an uplink transmission, wherein the RACH occasion is selected from the first set of RACH occasions when the WTRU is in a Radio Resource Control (RRC) idle state, and wherein the RACH occasion is selected from the second set of RACH occasions when the WTRU is in an RRC connected state. The processor is further configured to send the uplink transmission via the selected RACH occasion.

In examples, the processor is further configured to select the RACH occasion from the first set of RACH occasions based on an index associated with the first reference signal when the WTRU is in the RRC idle state, and select the RACH occasion from the second set of RACH occasions based on an index associated with the second reference signal when the WTRU is in the RRC connected state. In examples, the uplink transmission comprises a Physical Random-Access Channel (PRACH) preamble. In examples, the first RACH configuration indicates a first set of RACH parameters and the second RACH configuration indicates a second set of RACH parameters, and the processor is further configured to select RACH parameters for sending the uplink transmission, where the RACH parameters are the first set of RACH parameters when the WTRU is in the RRC idle state and the RACH parameters are the second set of RACH parameters when the WTRU is in the RRC connected state. In examples, the selected RACH parameters include at least one of time and frequency resources, association period, RACH Occasion Component Carrier, or RACH Occasion BWP. In examples, the first reference signal and the second reference signal are associated with a reference signal block. In examples, the processor is further configured to receive a plurality of reference signal blocks, where the plurality of reference signal blocks comprise the reference signal block and select the reference signal block based on a signal measurement associated with the reference signal block. In examples, the reference signal block comprises a synchronization signal block (SSB), the first reference signal comprises a first secondary synchronization signal (SSS), and the second reference signal comprises a second SSS. In examples, the first reference signal is associated with a wide beam and the second reference signal is associated with at least one of a differential beam or a narrow beam.

An example method performed by a Wireless Transmit/Receive Unit (WTRU) is disclosed. The method involves receiving a first reference signal and a second reference signal, where the first reference signal and the second reference signal are associated, and the first reference signal is associated with a first beam direction and the second reference signal is associated with a second beam direction. The method further involves receiving a first Random Access Channel (RACH) configuration associated with the first reference signal and a first set of RACH occasions, and a second RACH configuration associated with the second reference signal and a second set of RACH occasions. The method further involves selecting a RACH occasion for an uplink transmission, where the RACH occasion is selected from the first set of RACH occasions when the WTRU is in a Radio Resource Control (RRC) idle state, and the RACH occasion is selected from the second set of RACH occasions when the WTRU is in an RRC connected state. The method further involves sending the uplink transmission via the selected RACH occasion.

In examples, the method further involves selecting the RACH occasion from the first set of RACH occasions based on an index associated with the first reference signal when the WTRU is in the RRC idle state or selecting the RACH occasion from the second set of RACH occasions based on an index associated with the second reference signal when the WTRU is in the RRC connected state. In examples, the uplink transmission comprises a Physical Random-Access Channel (PRACH) preamble. In examples, the first RACH configuration indicates a first set of RACH parameters and the second RACH configuration indicates a second set of RACH parameters, and the method further involves selecting RACH parameters for sending the uplink transmission, wherein the RACH parameters are the first set of RACH parameters when the WTRU is in the RRC idle state and the RACH parameters are the second set of RACH parameters when the WTRU is in the RRC connected state. In examples, the selected RACH parameters include at least one of time and frequency resources, association period, RACH Occasion Component Carrier, or RACH Occasion BWP. In examples, the first reference signal and the second reference signal are associated with a reference signal block. In examples, the method further involves receiving a plurality of reference signal blocks, where the plurality of reference signal blocks comprise the reference signal block and selecting the reference signal block based on a signal measurement associated with the reference signal block. In examples, the reference signal block comprises a synchronization signal block (SSB), the first reference signal comprises a first secondary synchronization signal (SSS), and the second reference signal comprises a second SSS. In examples, the first reference signal is associated with a wide beam and the second reference signal is associated with at least one of a differential beam or a narrow beam.

Another example wireless transmit/receive unit (WTRU) is disclosed that includes a processor. The processor is configured to receive a first reference signal and a second reference signal, where the first reference signal and the second reference signal are associated, and the first reference signal is associated with a first beam direction and the second reference signal is associated with a second beam direction. The processor is further configured to receive an indication of a first Random Access Channel (RACH) occasion associated with a first mode of operation and the first reference signal, and a second RACH occasion associated with a second mode of operation and the second reference signal. The processor is further configured to select a RACH occasion for a Physical Random-Access Channel (PRACH) preamble transmission, wherein the first RACH occasion is selected when the WTRU is in the first mode of operation, and the second RACH occasion is selected when the WTRU is in the second mode of operation. The processor is further configured to send the PRACH preamble transmission via the selected RACH occasion.

In examples, the first mode of operation of the WTRU comprises at least one of being in an Radio Resource Control (RRC) idle state, uplink and downlink being decoupled with respect to an uplink and downlink spatial filter, one or more WTRU capabilities not meeting a threshold, one or more coverage conditions not meeting a threshold, or using on-demand reference signal burst type. In examples, the second mode of operation of the WTRU comprises at least one of being in an RRC connected state, uplink and downlink being coupled with respect to the uplink and downlink spatial filter, one or more WTRU capabilities exceeding a threshold, one or more coverage conditions exceeding a threshold, or using always on reference signal burst type.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 provides an example of an RS block that includes a first SSS and a second SSS.

### DETAILED DESCRIPTION

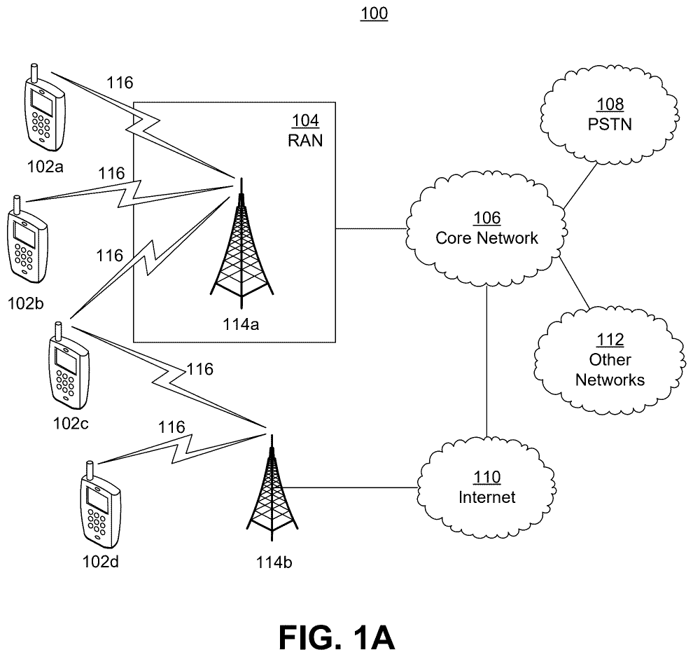

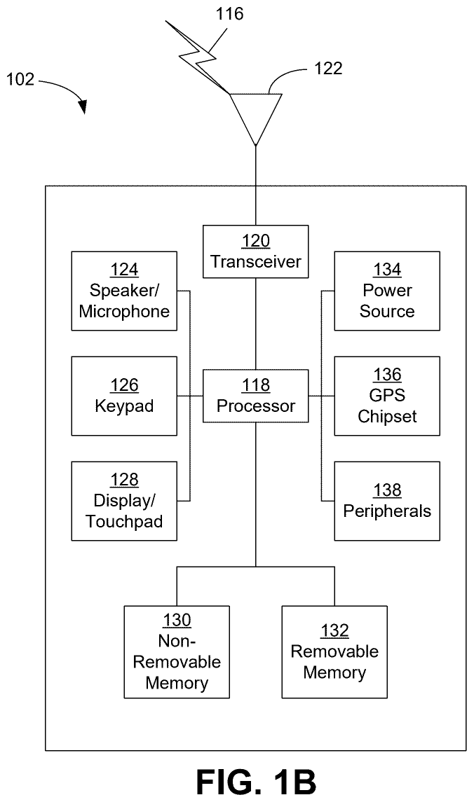

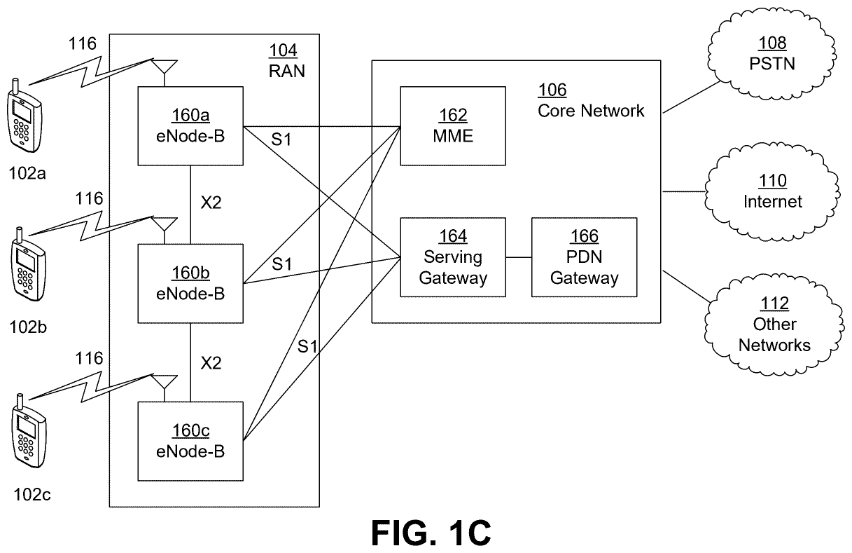

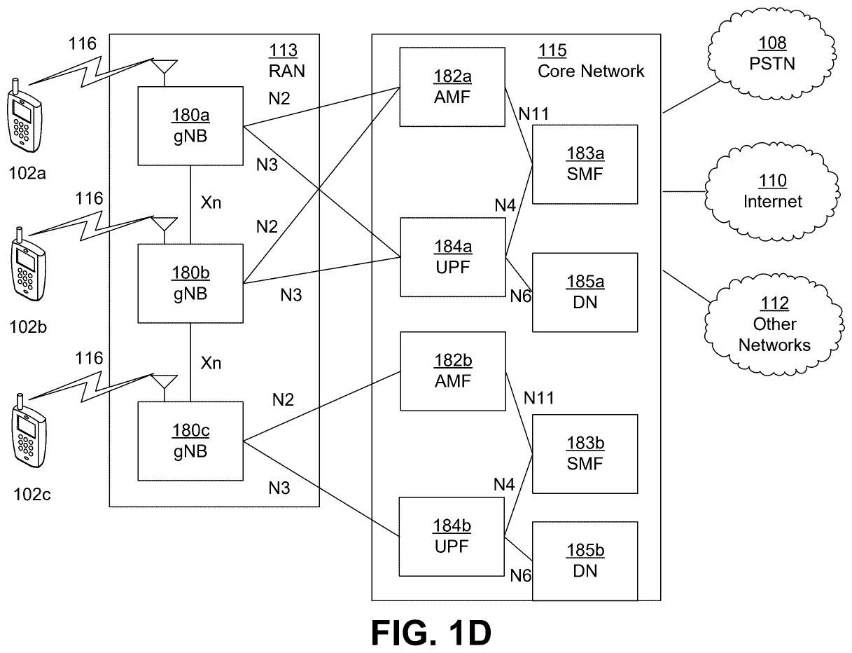

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In systems with different types of SSB bursts and different modes of operation, determining the RACH occasions (RO) during the initial access procedure may require more configuration information to be indicated to the WTRU, increasing the payload for the already limited MIB and System Information Block (SIB). Yet, some information such as Quasi-Colocation (QCL) information, beam directions, and the association of the beams cannot be efficiently indicated only based on some information. In an example, in a decoupled UL/DL framework, when an SSB is detected, the DL beam direction and pathloss may be concluded based on the detected SSB. However, the WTRU may have no means for determining the UL beam direction or pathloss for determining the UL beam direction and PRACH UL power, during random access procedure and PRACH preamble transmission.

Therefore, systems and methods for selecting ROs for PRACH preamble transmission during initial access procedure are desirable.

Systems and methods for selecting Random Access Channel (RACH) occasions (ROs) for Physical Random Access Channel (PRACH) preamble transmission during initial access procedure based on different modes of operation are disclosed.

In systems and methods disclosed herein, different reference signals (RSs) may be used for different modes of operation. For example, different RSs may be used for the RRC-Idle/Inactive modes and the Radio Resource Control (RRC)-Connected mode. By using the RS decoupling, energy saving gain can be obtained by reducing or eliminating RSs for specific RRC state modes. This allows the network to dynamically and flexibly handle the RSs with respect to overhead, energy saving, spatial and/or power domain adaptation, and so forth.

RACH Occasion (RO) may be selected based on modes of operation.

A WTRU may be configured with a reference signal (RS) block, where the RS block includes a first RS with a first beam direction and a second RS with a second beam direction. The first and second RSs may be multiplexed in time within the RS block. The WTRU may select to use the first or the second RSs based on the modes of operation. The WTRU may select the RO for PRACH preamble transmission based on the selected RS. The disclosed embodiments enable the efficient indications as part of Synchronization Signal Blocks (SSBs) on RO selection during initial access procedure, allowing low latency random access and connection.

A WTRU that is performing a random access procedure may detect, receive, and/or measure one or more reference signals (RSs), for example, from one or more RS blocks (e.g., SSBs), e.g., from one or more RS bursts.

RS blocks (e.g., SSBs) are indexed based on RS block index in the burst. Each RS block may include one or more of Primary Synchronization Signal (PSS), Secondary Synchronization Signal (SSS), Physical Broadcast Channel (PBCH), PBCH Demodulation Reference Signal (DM-RS), and/or more than one RSs.

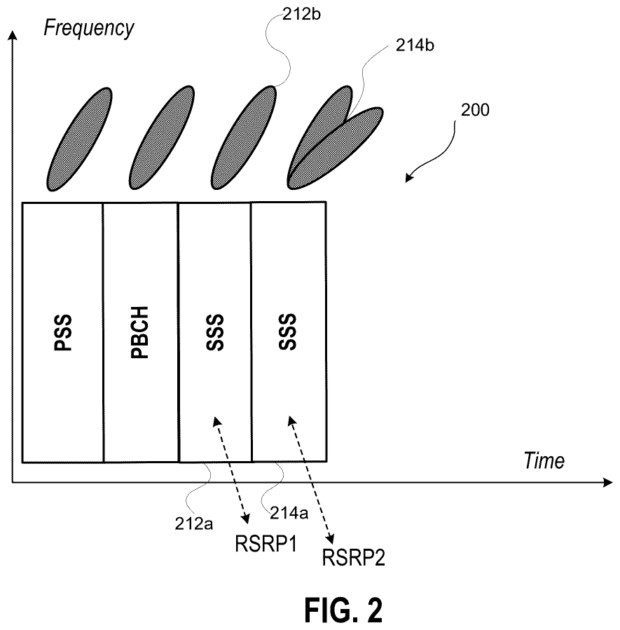

FIG. 2 depicts an example RS block 200 (e.g., which may be an SSB). The RS block 200 may include a first RS associated with a first SSS 212a and a second RS associated with a second SSS 214a. The first SSS 212a may be associated with a first beam direction 212b (e.g., a first TCI-state). The first beam direction 212b may be associated with a wide beam.

The second SSS 214a may be associated with a second beam direction 214b (e.g., a second TCI-state). The second beam direction 214b may be associated with a differential and/or narrow beam. The second SSS 214a may be associated with a second differential TCI-state. The differential beam direction 214b may be based on the first beam direction 212b (e.g., the differential beam direction may deviate by a certain number of degrees from the first beam direction). Although two possible differential beams are shown by 214b, the WTRU uses only one differential beam for transmission and/or reception.

The first reference signal and the second reference signal may be multiplexed in time within the RS block 200.

The WTRU may select an RS and the corresponding RS block, from the RS block burst. The selected RS may be the “best” RS (e.g., based one or more measurements). For example, the selected RS may be the RS with the highest measured Reference Signal Received Power (RSRP).

The WTRU may receive configuration information. The configuration information may include RACH configurations for one or more RACH Occasion (RO) types associated with one or more modes of operation (e.g., via SIB1), such as services, WTRU capabilities, uplink (UL)/downlink (DL) decoupling, RS decoupling, multi-carrier operation, coverage enhancement, low-power operation, network energy saving (NES), and the like. Additionally, or alternatively, the configuration information may include time and frequency resources, association period, RO's CC, ROs Bandwidth Part (BWP), and the like.

The WTRU may select the RO type and one or more RACH parameters to be used for PRACH transmission (e.g., pathloss, PRACH UL power, spatial filter, etc.) based on the mode of operation.

The WTRU may use the first RS in the selected RS block as the RS for the QCL information for the DL Transmission Configuration Indicator (TCI)-state and the second RS as the RS for the QCL relation for the UL TCI-state.

The WTRU may determine the RACH parameters based on the second RS (e.g., UL spatial filter for PRACH preamble transmission, pathloss, PRACH UL power, etc.).

After the PRACH transmission, the WTRU may use the first RS as the RS for DL TCI-state for the QCL assumption for Random Access Response (RAR) reception.

The WTRU may select the RO type that is associated with the UL/DL decoupling (e.g., in the UL carrier, based on which the WTRU uses the RACH configuration).

The WTRU may select the RO for PRACH preamble transmission based on the selected RS block index and the selected RO type.

The WTRU may transmit PRACH preamble on the selected RO. The WTRU may report the RSRP measurement for both RSs (e.g., as part of Msg3 or later in RRC-Connected mode as part of Channel State Information (CSI) reporting).

A WTRU performing random access procedure may select an RS and the corresponding RS block, from the RS block burst. The selected RS may be the “best” RS (e.g., based on one or more measured and/or evaluated parameters). For example, the selected RS may be the RS with the highest measured Reference Signal Received Power (RSRP). The RS block may include a first RS and a second RS. The WTRU may receive RACH configurations for one or more RO types associated with one or more modes of operation (e.g., via SIB1). The configuration information may include time and frequency resources, RO's Component Carrier (CC), RO's bandwidth part (BWP), and the like.

The WTRU may select the RO type and one or more RACH parameters to be used for PRACH transmission (e.g., pathloss, PRACH UL power, spatial filter, etc.) based on the mode of operation.

When in the RRC-Idle/Inactive mode, the WTRU may use the first RS in the selected RS block as the RS for the QCL relation for the UL and DL TCI-states (e.g., for PRACH transmission, and RAR reception.) and may use the RACH configuration associated with a first RO type in a first configured (e.g., initial) BWP.

When in the RRC-Connected mode, the WTRU may use the second RS as the RS for the UL and DL TCI-states and may use the RACH configuration associated with a second RO type in a second configured (e.g., active BWP).

The low-end WTRU may use the first RS in the selected RS block as the reference for determining spatial filter for PRACH preamble transmission, pathloss, PRACH UL power, repetition factor, and the like. The low-end WTRU may use a third RO type associated with a first carrier (e.g., basic reference CC that can be used for all WTRUs).

The high-end WTRU may use the second RS in the selected RS block as the RS for the QCL relation for the UL/DL TCI-state and for determining pathloss, PRACH UL power, repetition factor, and the like. The WTRU may use a fourth RO type associated with a second carrier (e.g., associated with a configured service and/or WTRU capabilities).

A WTRU that is using on-demand RSs (e.g. SSB bursts and/or CSI-RSs, SSB bursts with longer periodicity, larger number of RSs, narrow-beam SSBs) may need to fall back to always-on RSs (e.g., SSB bursts with lower periodicity, fewer number of SSBs, wide-beam SSBs) due to one or more events, (e.g., Bidirectional Forwarding Detection (BFD), Low-layer Triggered Mobility (LTM), User Equipment Initiated Bearer Release (UEIBR), and the like). Always on RSs may be based on RS blocks, where the WTRU selects one of the RS blocks (e.g., based on one or more measured and/or evaluated parameters). The WTRU may use the first RS within the RS block for determining the Ros in the fifth RO tyle. The WTRU may use the second RS for early fine-tuning of the beam direction to be used for PRACH transmission and/or selective receiving of on-demand RSs.

A good-coverage WTRU may measure a first RSRP (e.g., RSRP1) and a second RSRP (e.g., RSRP2) based on the first RS and the second RS, respectively. The WTRU may then select an RS. The WTRU may select the RS based one or more measurements. For example, the WTRU may select the RS with the highest RSRP. The WTRU may use a sixth RO type associated with coverage enhancement, where the WTRU uses PRACH preamble partitioning for indicating which RS was selected.

A low-coverage WTRU may use the first RS and the second RS for accumulating the RSRP measurements and averages the RSRP based on the RS block. Due to the bundled RSs in the RS block, the WTRU can measure RSRP with lower latency. The WTRU may use a seventh RO type associated with low-coverage.

The WTRU may select the RO for PRACH preamble transmission based on the selected RS block index and the selected RO type.

The WTRU may transmit PRACH preamble on the selected RO and monitor to receive RAR in the configured resources within the RAR window. The WTRU may report the RSRP measurement for both RSs (e.g., as part of Msg3 or later in RRC-Connected mode as part CSI reporting).

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by Medium Access Control (MAC) Control Element (CE) or Downlink Control Information (DCI). For example, WTRU may implicitly transmit Physical Uplink Shared Channel (PUSCH) and DM-RS of PUSCH according to the same spatial domain filter as a Sounding Reference Signal (SRS) indicated by a SRS Resource Indicator (SRI) indicated in DCI or configured by RRC. A spatial relation may be configured by RRC for a SRI or signaled by MAC CE for a Physical Uplink Control Channel (PUCCH). Such spatial relation may also be referred to as a “beam indication”.

The WTRU may receive a first (e.g., target) downlink channel or signal according to the same spatial domain filter or spatial reception parameter as a second (e.g., reference) downlink channel or signal. For example, such association may exist between a physical channel such as Physical Downlink Control Channel (PDCCH) or Physical Downlink Shared Channel (PDSCH) and its respective DM-RS. Where the first and second signals are reference signals, such association may exist when the WTRU is configured with a QCL assumption type D between corresponding antenna ports. Such association may be configured as a TCI-state. A WTRU may be indicated an association between a CSI-RS or SS block and a DM-RS by an index to a set of TCI states configured by RRC and/or signaled by MAC CE. Such indication may also be referred to as a “beam indication”.

A WTRU may receive one or more TCI related configurations. The one or more TCI related configurations may comprise a plurality of TCI-states (e.g., an RRC-configured pool of TCI-states, such as Unified TCI framework), ‘TCI-State’ IE, ‘TCI-UL-State’ IE, ‘spatialRelationInfo’ IE, and the like. A TCI-state of the plurality of TCI-states may be associated with at least one of: QCL-info #1, QCL-info #2 (where QCL-info #1 or QCL-info #2 may comprise a cell-ID (e.g., serving-cell index)), additionalPCI, pathloss RS (PLRS)-ID, Uplink Power Control (UL-PC), Timing Advance Group (TAG)-ID, a BWP-ID, a RS (e.g., CSI-RS, SSB-index), and/or a QCL-type which may be one of typeA, typeB, typeC, typeD.

The PLRS-ID may be for pathloss estimation for determining a UL transmission power when a UL transmission is based on a TCI-state that is associated with the PLRS-ID. The UL-PC (e.g., UL-PC parameter set, which may comprise at least one of P0, alpha, close-loop (CL)-index, power offset, etc.) may be for determining an uplink power for an UL transmission associated with the TCI-state. The additionalPCI may be a physical cell-ID (PCID) of a neighboring (e.g., surrounding) cell that the RS associated with the TCI-state (e.g., SSB-index or CSI-RS) may be transmitted from. The RS associated with the TCI-state may be transmitted as an inter-cell beam or RS reference. The WTRU may apply a timing advance value (e.g., based on one or more received timing advance commands (TACs)) in association with the TAG-ID (e.g., of multiple TAG-IDs being configured) to a scheduled UL transmission.

Type A may represent {Doppler shift, Doppler spread, average delay, delay spread}. Type B may represent {Doppler shift, Doppler spread}. Type C may represent {Doppler shift, average delay}. Type D may represent {Spatial Rx parameter}.

When a WTRU receives an indication or configuration of a TCI-state (e.g., applicable for a physical channel or signal) at least comprising a QCL-type (e.g., by Type A, Type B, Type C, or Type D) and an RS (e.g., an RS associated with the QCL-type), the WTRU may determine (e.g., derive) at least one parameter for transmission and/or reception. The at least one parameter may represent wireless channel characteristics (e.g., at least one of Doppler shift, Doppler spread, average delay, delay spread, Spatial Rx parameter) based on the indicated QCL-type, The WTRU may apply the at least one parameter for transmission or reception of the physical channel or signal.

A unified TCI (e.g., a common TCI, a common beam, a common RS, etc.) may refer to a beam/RS to be used simultaneously for multiple physical channels/signals. The term “Transmission Configuration Indicator (TCI)” may at least comprise a TCI state that includes at least one source RS to provide a reference (e.g., WTRU assumption) for determining QCL and/or spatial filter.

A WTRU may receive (e.g., from a base station such as a gNB) an indication of a first unified TCI to be used/applied for DCI (PDCCH) and a downlink shared channel (PDSCH). The first unified TCI may be used/applied for DCI (PDCCH), a downlink shared channel (PDSCH), and/or or a downlink RS. The one or more source reference signals in the first unified TCI may provide common QCL information at least for WTRU-dedicated reception on the PDSCH and all or subset of Coordinated Multi-Point Transmissions (CORESETs) in a CC. A WTRU may receive (e.g., from a base station such as a gNB) an indication of a second unified TCI to be used/applied for both an uplink control channel (PUCCH) and an uplink shared channel (PUSCH). The second unified TCI may be used/applied for an uplink control channel (PUCCH), an uplink shared channel (PUSCH), and/or an uplink RS. The one or more source reference signals in the second unified TCI may provide a reference for determining one or more common UL transmission spatial filters at least for dynamic-grant/configured-grant based PUSCH and all, or subset of, dedicated PUCCH resources in a CC.

The WTRU may be configured with a first mode for unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI).

A WTRU may receive (e.g., from a base station, a gNB, a TRP, etc.) an indication of a second unified TCI to be used/applied commonly for a PDCCH, a PDSCH, a PUCCH, and a PUSCH. The second unified TCI may be used/applied commonly for a PDCCH, a PDSCH, a PUCCH, a PUSCH, a DL RS, and/or a UL RS.

The WTRU may be configured with a second mode for unified TCI (e.g., JointTCI mode, a parameter of ‘unifiedTCI-StateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may comprise PUCCH, PUSCH, and/or SRS. A reception may comprise PDCCH, PDSCH, and/or CSI-RS. A Unified TCI state instance may also be referred to TCI state group, TCI state process, unified TCI pool, a group of TCI states, a set of time-domain instances, stamps, slots, symbols, and/or a set of frequency-domain instances, RBs, subbands, etc. A Unified TCI state instance may be equivalent or identified to a Coreset Pool identity (e.g., CORESETPoolIndex, a TRP indicator, and/or the like).

As used herein, “unified Transmission Configuration Indicator (TCI)” may be interchangeably used with one or more of unified TCI-states, unified TCI instance, TCI, and TCI-state.

A WTRU may be configured with a plurality of TCI states. For example, the WTRU may be configured with a plurality of unified TCI (UTCI) states, each applicable for multiple channels/signals. The multiple channels/signals may be configured to the WTRU. Additionally, or alternatively, the multiple channels/signals may be pre-determined or defined, for example, in a form of a list, by a higher-layer signaling (e.g., RRC and/or MAC-CE) which may comprise at least one of: one or more CORESETs, one or more PDCCH candidates, one or more search spaces, one or more PDSCHs (e.g., PDSCH occasions/configurations/instances, etc.), one or more RSs (e.g., CSI-RSs, DM-RSs, SSB indexes, PRSs, PTRSs, and/or SRSs), one or more PUSCHs (e.g., PUSCH occasions/configurations/instances, etc.), one or more PUCCH resources (e.g., PUCCH resource sets/groups), and/or one or more PRACH occasions/resources/RSs.

The plurality of TCI states may be configured via an RRC signaling. Additionally, or alternatively, the plurality of TCI states may be configured via a MAC-CE signaling, indication or activation. The WTRU may receive (e.g., via the MAC-CE or a separate signaling) an information content comprising mapping between one or more codepoints of a DCI field (e.g., TCI field and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

As used herein, “transmit/receive point (TRP)” may be interchangeably used with one or more of Transmission Point (TP), Reception Point (RP), Radio Remote Head (RRH), Distributed Antenna (DA), base station, BS, a sector (of a base station), and a cell (e.g., a geographical cell area served by a base station). As used herein, Multi-TRP may be interchangeably used with one or more of MTRP, M-TRP, and multiple TRPs.

A WTRU may be configured with, or may receive configuration of, one or more TRPs to which the WTRU may transmit and/or from which the WTRU may receive. The WTRU may be configured with one or more TRPs for one or more cells. A cell may be a serving cell, secondary cell.

A WTRU may be configured with at least one RS for the purpose of channel measurement. This RS may be denoted as a Channel Measurement Resource (CMR) and may comprise a CSI-RS, SSB, or other downlink RS transmitted from the TRP to a WTRU. A CMR may be configured or associated with a TCI state. A WTRU may be configured with a CMR group where CMRs transmitted from the same TRP may be configured. Each group may be identified by a CMR group index (e.g. group 1). A WTRU may be configured with one CMR group per TRP, and the WTRU may receive a linkage between one CMR group index and another CMR group index, or between one RS index from one CMR group and another RS index from another group.

A WTRU may be configured with, or receive configuration of, one or more pathloss reference groups (e.g., sets) and/or one or more SRS groups, SRIs, or SRS resource sets.

A pathloss reference group may correspond to or may be associated with a TRP. A pathloss reference group may include, identify, correspond to, or be associated with one or more TCI states, SRIs, reference signal sets (e.g. CSI-RS set, SRI sets), CORESET index, and/or reference signals (e.g. CSI-RS, SSB).

A WTRU may receive configuration information (e.g., any configuration described herein). The configuration may be received from a gNB or TRP. For example, the WTRU may receive configuration of one or more TRPs, one or more pathloss reference groups, and/or one or more SRI sets. A WTRU may implicitly determine an association between a RS set/group and a TRP. For example, if the WTRU is configured with two SRS resource sets, then the WTRU may determine to transmit to TRP1 with SRS in the first resource set, and to TRP2 with SRS in the second resource set. The configuration information may be via RRC signaling.

As used herein, TRP, pathloss reference group, SRI group, and SRI set may be used interchangeably. The terms set and group may be used interchangeably herein.

A WTRU may report a subset of CSI components, where CSI components may correspond to at least a CSI-RS Resource Indicator (CRI), a SSB Resource Indicator (SSBRI), an indication of a panel used for reception at the WTRU (e.g., a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least Rank Indicator (RI), Channel Quality Indicator (CQI), Precoding Matrix Indicator (PMI), Layer Index (LI), and/or the like.

A WTRU may be configured with one or more CSI report configurations. The CSI report configurations may include one or more of the following: (i) report configuration type (e.g., periodic, semi-persistent on PUCCH, semi-persistent on PUSCH or aperiodic), (ii) report quantity (e.g., CRI-RI-PMI-CQI, CRI-RI-i1, CRI-RI-i1-CQI, CRI-RSRP, SSB-Index-RSRP, CRI-RI-LI-PMI-CQI, CRI-SINR, SSB-Index-SINR), (iii), report frequency configuration (e.g., CQI format indicator (wideband CQI or subband CQI), PMI format indicator (wideband PMI or subband PMI), CSI reporting band), (iv) time restriction for channel measurements, (v) time restriction for interference measurements, (vi) codebook configuration, (vii) group based beam reporting, (viii) CQI table, (ix) subband size, (x) non-PMI port indication, (xi) report slot config/offset list, (xii) CSI report periodicity and offset, (xiii) ne or more PUCCH resources for CSI reporting, and/or (xiv) port Index.

A WTRU may be configured with one or more CSI measurement configurations. The CSI measurement configurations may include one or more of following: (i) RS for channel measurement, (ii) RS for interference measurement (zero power or non-zero power), (iii) report trigger size, (iv) aperiodic trigger state list, (v) semi-persistent on PUSCH trigger state list, (vi) associated CSI resource configs, and/or (vii) associated CSI report configurations.

A WTRU may be configured with one or more CSI resource configurations. The CSI resource configuration may include one or more of following: (i) CSI resource config ID, (ii) one or more RS resource sets for channel measurement, (iii) one or more RS resource sets for interference measurement, (iv) bandwidth part ID, and/or (v) resource type (e.g., aperiodic, semi-persistent or periodic).

A WTRU may be configured with one or more RS resource sets. The RS resource set configuration may include one or more of following: (i) RS resource set ID, (ii) one or more RS resources for the RS resource set, (iii) repetition (e.g., on or off), (iv) periodic triggering offset (e.g., one of 0-6 slots), and/or (v) TRS info (e.g., true or not).

A WTRU may be configured with one or more RS resources. The RS resource configuration may include one or more of following: (i) RS resource ID, (ii) resource mapping (e.g., REs in a physical resource block (PRB)), (iii) power control offset (e.g., one value of −8, . . . , 15), (iv) power control offset with SS (e.g., −3 dB, 0 dB, 3 dB, 6 Db), (v) scrambling ID, (vi) periodicity and offset, and/or (vii) QCL information (e.g., based on a TCI state).

A WTRU may be operating during at least one of the one or more RRC states and/or RRC modes, for example including RRC-Connected state, RRC-Inactive state, and/or RRC-Idle state.

A WTRU may be operating in an RRC-Connected state, during which the WTRU may have connected, established RRC context, and/or have at least one RRC connection, for example, to one or more cells, base stations, gNBs, TRPs, etc. In RRC-Connected state, the WTRU may receive RRC context and/or one or more configuration information at least including one or more radio bearers, logical channels, PDU sessions, security information, etc. During RRC-Connected state, the connected WTRU may measure one or more of the following: Reference Signal Received Power (RSRP), Reference Signal Received Quality (RSRQ), Received Signal Strength Indicator (RSSI), and/or the like, based on one or more received, detected, configured, and/or indicated RSs received from serving cell and/or one or more neighboring cells. The connected WTRU may report the measured parameters, for example to the serving cell.

A WTRU may be operating in an RRC-Idle state, that may be the initial mode when the WTRU is powered up. The WTRU is RRC-Idle state is in a dormant state where the WTRU is not actively engaged in communication. The WTRU in RRC-Idle state may perform cell selection and/or cell reselection, where the WTRU receives, detects, measures, and/or selects an SSB, based on which the WTRU uses the PBCH, MIB, SIB, etc. The WTRU in RRC-Idle state may monitor the PDCCH (e.g., DCI, Format 1-0 using the P-RNTI) defined by the Discontinuous Reception (DRX) pattern. The WTRU may use respective 5G-S-TMSI to receive Paging messages in RRC-Idle state.

A WTRU may be operating in an RRC-Inactive state, where the WTRU keeps the RRC context and CORE network connection and does not release the RRC when switching from RRC-Connected state to RRC-Inactive state. The WTRU in RRC-Inactive state may be in a sleep mode, similar to RRC-Idle state, where the mobility may be handled through cell reselection without involvement of network.

As used herein, “signal” may be interchangeably used with one or more of following: Sounding Reference Signal (SRS), Channel State Information-Reference Signal (CSI-RS), Demodulation Reference Signal (DM-RS), Phase Tracking Reference Signal (PT-RS), and Synchronization Signal Block (SSB).

As used herein, “channel” may be interchangeably used with one or more of following: Physical Downlink Control Channel (PDCCH), Physical Downlink Shared Channel (PDSCH), Physical Uplink Control Channel (PUCCH), Physical Uplink Shared Channel (PUSCH), and Physical Random Access Channel (PRACH).

As used herein, “Reference Signal (RS) resource set” may be interchangeably used with a RS resource and a beam group.

As used herein, “beam” may be interchangeably used with TCI state, TCI state group, and beam pair.

As used herein, “beam reporting” may be interchangeably used with CSI measurement and CSI reporting and beam measurement.

As used herein, “beam ID” may be interchangeably used with beam index and beam pair ID.

As used herein, “Quasi-Colocation (QCL) reference signal” may be interchangeably used with a pathloss reference signal.

As used herein, component carrier (CC), carrier, and bandwidth part (BWP) may be used interchangeably, where a component carrier (CC) may imply a frequency block.

As used herein, “downlink reception” may be used interchangeably with reception occasion, Physical Downlink Control Channel (PDCCH), Physical Downlink Shared Channel (PDSCH), and Synchronization Signal Block (SSB) reception.

As used herein, “uplink transmission” may be used interchangeably with transmission occasion, Physical Uplink Control Channel (PUCCH), Physical Uplink Shared Channel (PUSCH), Physical Random Access Channel (PRACH), and Sounding Reference Signal (SRS) transmission.

As used herein, “Reference Signal (RS)” may be interchangeably used with one or more of RS resource, RS resource set, RS port and RS port group.

As used herein, RS may be interchangeably used with one or more of Synchronization Signal Block (SSB), Channel State Information (CSI) Reference signal (RS), Sounding Reference Signal (SRS), and Demodulation Reference Signal (DM-RS).

As used herein, “time instance” may be interchangeably used with slot, symbol, and subframe.

As used herein, “Unified Transmission Configuration Indicator (UTCI)” may be interchangeably used with Transmission Configuration Indicator (TCI), UTCI state, and TCI state.

As used herein, the terms received signal power, received signal energy, received signal strength, Synchronization Signal Block (SSB) Energy Per Resource Element (EPRE), Channel State Information (CSI) EPRE, Reference Signal Received Power (RSRP), Received Signal Strength Indicator (RSSI), SINR, Reference Signal Received Quality (RSRQ), Synchronization Signal (SS) Reference Signal Received Power (RSRP), SS-RSSI, SS-SINR, SS-RSRQ, CSI-RSRP, CSI-RSSI, CSI-SINR, and CSI-RSRQ may be used interchangeably.

As used herein, the terms “WTRU is configured”, “WTRU is indicated”, “WTRU receives configuration”, and so forth, may imply that the configuration is indicated for example “via RRC, MAC-CE, DCI, MIB, SIB, and so forth”, unless indicated otherwise, where for example, “WTRU is configured” may imply “WTRU is configured via RRC, MAC-CE, MIB, SIB, and so forth”.

Herein, the channel quality parameters may comprise the Radio Resource Management (RRM) measurements, however the solutions and examples in the disclosure may equally (or equivalently or extendedly, etc.) be employed (e.g., applicable) for cases with other quality parameters and/or values (e.g., RSRP, RSRQ, SNR, SINR, etc.).

A WTRU may determine, be configured, and/or indicated to perform random access procedure. The WTRU may determine to perform random-access procedure as part of initial access, and/or based on one or more events and/or indications. For example, the WTRU may perform random-access procedure due to beam failure detection (BFD) and as part of beam failure recovery (BFR) procedure. In another example, the WTRU may receive indications to perform random-access procedure based on an indicated and/or configured cell, TCI-state, etc. (e.g., indicated via PDCCH order, via DCI, MAC-CE, RRC, etc.). The WTRU may perform the random-access procedure based on one or more measured RSs (e.g., SSB, CSI-RS, etc.).

The WTRU may detect, receive, and/or measure one or more RSs. The WTRU may be configured with configuration information on the RS resources, where the configuration may include RS resource index. The RSs may be transmitted in one or more RS blocks, where the RS blocks may be transmitted in one or more RS block bursts. For example, each RS block may be configured with an RS block index. The WTRU may receive configuration information, and/or be configured and/or indicated that there may be an association between one or more RSs. The WTRU may be configured with a first RS and a second RS, where the WTRU may be configured and/or indicated that the first and the second RSs may be associated.

The WTRU may measure one or more parameters based on one or more RSs, where the WTRU may select an RS. The WTRU may selected the best RS (e.g., the RS with highest measured RSRP and/or lowest measured interference). If the RS is transmitted as part of an RS block, the WTRU may select the corresponding RS block (e.g., as the best).

The WTRU may receive and/or be configured and/or indicated with one or more configuration information on the random-access procedure (e.g., RACH procedure). The WTRU may receive the configuration information. The WTRU may receive the configuration information from a base station (e.g., a Node-B, for example via SIB, RRC, MAC-CE, DCI, etc. The configuration information may include time and frequency resource mapping, association period, RACH occasions' (RO) CC, ROs BWP, RS-to-RO mapping, etc.

The WTRU may be configured with one or more modes of operation. The modes of operation may include one or more of the following: services, WTRU capabilities, UL/DL decoupling, RS decoupling, multi-carrier operation, coverage enhancement, and/or the like. The WTRU may be configured with one or more RO type configurations based on different modes of operation. The WTRU may select the RO type based on one or more conditions and the mode of operation. Based on the selected RO type, the WTRU may select at least an RO for PRACH preamble transmission. The WTRU may select the RO based on the selected RS resource (e.g., RS resource index), selected RS resource block (e.g., RS resource block index), and so forth. The WTRU may transmit the PRACH preamble on the selected RO.

A WTRU may receive, be configured, and/or indicated with one or more RSs, where the WTRU may use one or more of the configured RSs based on the mode of operation. The configured RSs may be associated. For example, the WTRU may receive one or more configuration information on configured RSs, for example from a Node-B, for example via RRC, MAC-CE, DCI, SIB, and/or the like.

The WTRU may receive one or more configuration information on a first RS (e.g., SSB, CSI-RS resource), a second RS, and so forth. The first RS may have a QCL relation (e.g., Type D) with a first TCI state, where the first RS may be based on a wide beam. The second RS may have a QCL relation (e.g., Type D) with a second TCI state, where the second RS may be based on a narrow beam. A configured third RS may have a QCL relation (e.g., Type D) with a third TCI state, where the third RS may be based on a differential beam with respect to the first beam. That is, the third RS may be based on a beam that may be correlated with the first beam, for example with a difference in angle of arrival (AoA), angle of departure (AoD), etc. The first RS may be transmitted in a first carrier, CC, BWP, etc., where the second RS may be transmitted in a second carrier. The first RS may be associated with a first pathloss, where the second RS may be associated with a second pathloss, and so forth. In an example, the configuration information may include one or more indications that the first RS may be associated with the second RS.

The WTRU may be preconfigured, configured, indicated, and/or receive configuration information on one or more RS blocks. For example, the WTRU may be configured with one or more RSs that may be multiplexed in time and/or frequency in a configured RS block. The RS block may include one or more indications and/or configuration information (e.g., information bits) in addition to one or more RSs. The RS block may include a first RS, a second RS, and so forth. The RSs, indications, and/or configurations may be multiplexed in time and frequency based on configured resource mappings (e.g., resource elements (REs) in one or more PRBs). The RS resources included in an RS block may be associated with each other. For example, the second RS resource may be associated with the first RS resource.

The first RS resource may be associated with a first TCI state and the second RS resource may be associated with a second TCI state. For example, the second TCI state may be associated with the first TCI state, where the spatial filter used to send and/or receive based on the second TCI state may have a relation (e.g., a differential relation) with the spatial filter used to send and/or receive based on the first TCI state. The first RS and/or the first TCI-state may be based on a wide beam, whereas the second RS and/or the second TCI-state may be based on a narrow beam.

An RS block may be associated with an RS block index, where the WTRU may determine the RS block's index based on one or more information bits included in the RS block. In another example, one or more RS blocks may be transmitted in one or more RS block bursts. That is, one or more RS blocks may be transmitted consecutively in configured time and frequency resources within a configured time duration. The RS block burst may be transmitted periodically, aperiodically, and/or semi-persistently. The WTRU may be configured and/or preconfigured and/or receive configuration information including the time, frequency, order of the RS blocks, time duration, periodicity, etc. with respect to one or more RS blocks.

The WTRU may be configured with one or more SSBs, where one or more SSBs may be transmitted in one or more SSB bursts. An SSB may include one or more PSS, PBCH, DMRS, and/or SSSs. FIG. 2 provides an example of an RS block 200 (e.g., SSB). In this example, the SSB includes PSS, PBCH, PBCH DM-RS and two SSS. The first SSS may be associated with a first RS and the second SSS may be associated with a second RS.

In an example, a WTRU may receive one or more configuration information and/or indications on the associated RSs. The indications may include an explicit indication and/or an implicit indication.

In embodiments where there is an explicit indication, the WTRU may receive one or more indications on the associated RSs and/or associated RS pairs. The configuration information on the first RS resource may include the RS-index of the second RS resource as the associated RS resource (e.g., AssociatedRSresourceID); the configuration information on the second RS may include the RS-index of the first RS as the associated RS, and so forth. The WTRU may receive a table and/or list of RS pairs and/or RS-index pairs that may be associated. For example, the first RS-index in the indicated RS-index pair may correspond to a first RS and the second RS-index in the indicated RS-index pair may correspond to a second RS that may be associated with the first RS. The RS index may correspond to the CSI-RS resource index, CSI-RS resource set index, TCI-state, SSB index, and so forth with regards to the corresponding RS.

In embodiments where there is an explicit indication, the configuration information on a first RS resource set may include the index to a second RS resource set, e.g., as the associated RS resource set (e.g., AssociatedRSresourceSetID). For example, the WTRU may determine, be configured, preconfigured, and/or indicated that there may be an association between the RS resources configured in the first RS resource set and the RS resources in the second RS resource set. In an example, the WTRU may be configured and/or indicated that there may be a one-to-one association between the RS resources in the first RS resource set and the RS resources in the second RS resource set.

In embodiments where there is an explicit indication, the WTRU may be configured and/or indicated that there may be a one-to-many association between the RS resources in the first RS resource set and the RS resources in the second RS resource set. That is, each RS resource in the first RS resource set may be associated with more than one RS resources in the second RS resource set. The WTRU that has selected a first RS resource, for example to be used in a first mode of operation, may determine the second RS resource from the second RS resource set, e.g., to be used in a second mode of operation, based on one or more measured and/or evaluated parameters. The measured parameters may be based on the first RS. The measured parameters may be based on at least one of the second RS resources. For example, the measured parameters may include RSRP, RSSI, SINR, RSRQ, PMI, LI, etc. The evaluated parameters may be based on the first RS and/or the second RS. For example, the evaluated parameters may include the ratio and/or the difference between the RSRP measured based on the first and second RSs, the difference and/or the ratio between the AoA measured based on the first and the second RSs, the difference and/or the ratio between the pathloss measured based on the first and the second RSs, and so forth.

In embodiments where there is an explicit indication, the WTRU may be configured and/or indicated that there may be a many-to-one association between the RS resources in the first RS resource set and the RS resources in the second RS resource set. That is, more than one RS resources in the first RS resource set may be associated with an RS resource in the second RS resource set. In an example, in such cases, the WTRU that has selected at least one of the first RS resources, for example to be used in a first mode of operation, may use the second RS resource, e.g., in a second mode of operation.

In embodiments where there is an explicit indication, the WTRU may receive a table and/or list of RS pairs and/or RS-index pairs that may be associated. For example, the first RS-index in the indicated RS-index pair may correspond to a first RS and the second RS-index in the indicated RS-index pair may correspond to a second RS that may be associated with the first RS. In an example, the RS index may correspond to the CSI-RS resource index, CSI-RS resource set index, TCI-state, SSB index, and so forth with regards to the corresponding RS.

In embodiments where there is an implicit indication, the WTRU may (e.g., implicitly) determine the association between one or more RS resources based on one or more configurations, indications, and/or conditions. The WTRU may receive or may be configured and/or indicated to receive RS blocks. The WTRU may determine, be configured, and/or indicated that the RS resources included in the RS block may be associated with each other. That is, in case an RS block includes more than one RS resources, the WTRU may determine that the RS resources in the RS block may be associated.

A WTRU may receive one or more configuration information on one or more of the following: RS resources, TCI states, modes of operation, and/or CORSETS and/or search spaces.

The WTRU may be configured with one or more RS resources. For example, the WTRU may be configured with a first RS resource set. The first RS resource set may be configured with one or more first RS resources. Additionally, or alternatively, the WTRU may be configured with a second RS resource set. The second RS resource set may be configured with one or more second RS resources.

An RS resource may be configured with one or more of: an indication to a second RS to which the first RS is associated, a reference RS for QCL Type (e.g., Type-A/B/C), a reference RS for QCL Type-D, resource mapping (e.g., REs in a PRB), power control offset, power control offset with a third RS (e.g., an SSS in an SSB), scrambling ID, periodicity, offset, one or more threshold values, and so forth.

The WTRU may be configured with one or more TCI states. An indication of a TCI state may include one or more indications on one or more reference RS resources.

The WTRU may be configured with one or more modes of operation, where the WTRU may determine, be configured, and/or indicated on the mode of the operation to be used. The WTRU may be configured with a first mode of operation, a second mode of operation, and so forth. The WTRU may determine a mode of operation based on WTRU capabilities. The WTRU may determine the mode of operation based on one or more explicit indications, for example from a Node-B. The WTRU may implicitly determine the mode of operation based on one or more conditions, threshold values, triggered events, etc. As an example, one or more modes of operation may include: UL/DL decoupling, RS decoupling, multi-carrier operation, coverage enhancement, low-power operation, network energy saving (NES), different service operations, and/or the like.

The WTRU may receive configuration information and/or indications, for example including the indications on the association between the RS resources and one or more modes of operation. The WTRU may receive the indications as part of the configuration information on RS resource(s) and/or RS resource set(s). The WTRU may be configured, indicated, and/or receive a flag indication on whether a configured RS may be used in operation based on a first mode of operation or not. The WTRU may receive the indications as part of the configuration information on an RS block. The WTRU may be configured, indicated, and/or receive one or more flag indications on whether a first RS in the RS block may be used in operation based on a first mode of operation or not; whether a second RS in the RS block may be used in operation based on a second mode of operation or not, and so forth.

The WTRU may be configured with one or more CORESETs and/or search spaces associated with one or more modes of operation. A first CORESET and/or search space may be associated with a first mode of operation and a second CORESET and/or search space may be associated with a second mode of operation. The configurations on the CORESETs and/or search spaces may include the time and/or frequency resources, center frequency, frequency offset, periodicity, etc. Additionally, or alternatively, the configurations may include the carrier in which the corresponding CORESET and/or search space may be configured. A first CORESET and/or search space may be configured in a first carrier; a second CORESET and/or search space may be configured in a second carrier, and so forth.

A WTRU may receive, identify, or be configured with one or more configuration information on one or more (e.g., consecutive) RACH Occasions (RO). The RACH configurations may be indicated based on one or more indexes corresponding to one or more tables that include random access parameters. One or more of the following configurations may be included:
(i) Frame number, subframe number, and/or slot number. For example, the WTRU may be configured with time-domain allocations, subframe number, and/or slot numbers during which the ROs may be configured. Using this parameter, the WTRU may determine the RO slot, for example within the corresponding subframe, where the WTRU may transmit the configured PRACH preamble in one or more of the determined ROs.
(ii) Starting symbol. For example, the WTRU may determine the symbol-level index corresponding to the starting position of the first RO's transmission within the indicated and/or configured RO slot.
(iii) Number of PRACH slots. For example, the WTRU may be indicated with the number of PRACH slots within a reference slot.
(iv) Number of time-domain PRACH occasions within a PRACH slot. For example, the WTRU may be configured with the number of consecutive ROs that are located within a PRACH slot in time domain.
(v) PRACH duration. For example, the WTRU may be configured with the duration of an RO, for example in number of symbols.
(vi) Preamble format. For example, the WTRU may be configured with preamble format that may refer to one of the possible formats, namely: A1, A2, A3, B1, A1/B1, A2/B2, A3/B3, B4, C0, C2. The preamble format may identify the corresponding Cyclic Prefix (CP) duration, sequence part duration, guard time duration (if applicable), etc.
(vii) Frequency start. For example, the frequency start indicates the offset of the lowest PRACH transmission occasion in frequency domain with respect to a reference, e.g., PRB 0.
(viii) Frequency Division Multiplexing (FDM)-ed ROs. For example, the FDM-ed ROs indicate the number of PRACH transmission occasions that are FDM-ed in one time-domain RO. The WTRU may receive, identify, or be configured with the number of ROs in frequency domain (M) per each time-domain PRACH occasion, where for example M={one, two, four, eight}. The WTRU may determine the number of the PRACH frequency resources {0, 1, . . ., M−1}, starting from the lowest frequency, in increasing order in the (e.g., initial) uplink BWP.
(ix) Preamble received target power. For example, the WTRU may receive initial random access preamble power, e.g., for the transmission of Msg 1 or Msg A.
(x) RSRP Threshold for repetition number X, e.g., of Msg1 or MsgA. For example, the WTRU may receive configuration on the RSRP threshold, based on which the WTRU may determine to perform PRACH preamble repetition for X times. In an example, if the WTRU determines that the measured DL pathloss RSRP is lower than the received threshold for repetition number X, the WTRU may perform PRACH repetition for X times.
(xi) Power ramping step. For example, the WTRU uses the configured with power ramping step for increasing the PRACH transmission power, up to a configured maximum number of times (e.g., preambleTransMax), or until RAR is received.
(xii) Maximum number of preamble transmission (e.g., preambleTransMax). For example, the WTRU may be configured with the maximum number of Random Access Preamble transmission (e.g., Y), where the WTRU may increase the UL transmission power at each PRACH transmission occasion based on power ramping step. A WTRU that is configured with a repetition number X, may perform PRACH repetition for X times, where the WTRU may transmit each repetition up to Y times that is the configured maximum number of allowed preamble transmission times. The WTRU may stop PRACH transmission if RAR is received. In case RAR is not received, and maximum number of preamble transmission is reached, the WTRU may switch to repetition with the next available higher repetition number.

A WTRU may receive the association and mapping between the RS and/or RS block indexes and the ROs based on one or more parameters indicating the number of RS and/or RS block indexes associated with an RO, within an RS-to-RO mapping cycle. In embodiments, a RACH association period, starting from frame 0, for mapping RS and/or RS block indexes to ROs is the smallest integer number in the set determined by the PRACH configuration period, such that the RS and/or RS block indexes are mapped at least once to the ROs within the association period.

The WTRU may determine the PRACH power, for example for PRACH preamble transmission. The WTRU may determine the PRACH power based on one or more configuration information, indication, and/or measured parameters. The WTRU may determine the PRACH power based on the configured preamble received target power (e.g., PREAMBLE_RECEIVED_TARGET_POWER), a determined, measured, and/or calculated pathloss, power ramping counter, power ramping step, and so forth. The WTRU may limit the power by a maximum power (e.g., Pcmax).

The WTRU may determine the maximum output power it may use for a transmission based on one or more of the following: the WTRU's power class maximum power, power reductions allowed for meeting requirements such as emissions or SAR (Specific Absorption Rate) requirements, reductions related to tolerances, and the signaled maximum power, Pcmax, etc.

A WTRU may receive, be configured, and/or indicated with one or more configuration information on random-access operation, where the different configured RACH configurations may correspond to the different configured RO types. For example, the different RO types may be associated with and/or correspond to the different modes of operation. A WTRU that may be operating based on a first mode of operation, may select one or more ROs for PRACH preamble transmission from a first configured RO type, that may be configured based on a first RACH configuration; the WTRU that may be operating based on a second mode of operation, may select one or more ROs for PRACH preamble transmission from a second configured RO type, that may be configured based on a second RACH configuration; and so forth. The WTRU may receive the RACH configurations on different RO types, via SIB, RRC, MAC-CE, DCI, etc.

The WTRU may receive, be configured, and/or indicated with RACH configurations for different RO types, for example, for different modes of operation, based on separate RACH configurations and/or joint RACH configurations.

For separate RACH configurations, the WTRU may be configured with a first RO type based on a first set of RACH configurations for a first mode of operation and a second RO type based on a second set of RACH configurations for a second mode of operation. The first and the second RACH configurations may be indicated and/or configured separately, via SIB, MAC-CE, DCI, RRC, etc.

For joint RACH configurations, n some embodiments, the WTRU may be configured with a first set of RACH configurations, where the WTRU may use the same first RACH configurations for determining the ROs corresponding to a first RO type and a second RO type. A WTRU may be operating based on a first mode of operation, where the WTRU may be operating based on a first set of operation configurations. For example, the first set of operation configurations may include a first set of time and frequency resources, a first carrier, a first BWP, a first power setting, a first UL/DL direction, a first service, etc. in the first mode of operation. The WTRU may be operating based on a second mode of operation, where the WTRU may be operating based on a second set of operation configurations. For example, the second set of operation configurations may include a second set of time and frequency resources, a second carrier, a second BWP, a second power setting, a second UL/DL direction, a second service, etc. in the second mode of operation.

If the WTRU is operating based on the first mode of operation, the WTRU may use the first configured joint RACH configurations for determining the ROs, based on the first set of operation configurations. In another example, if the WTRU is operating based on the second mode of operation, the WTRU may use the first configured joint RACH configurations for determining the ROs, based on the second set of operation configurations.

The WTRU that is configured with the first joint PRACH configurations may be configured and/or indicated to use one or more second parameters, for example separately or differently from the first joint RACH configurations, for example when operating based on the second mode of operation. That is, although the same first configuration may be used for the first and the second modes of operation, the WTRU may be configured with one or more second parameters to be used in the second mode of operation. The second parameters may include one or more of PREAMBLE_RECEIVED_TARGET_POWER, power ramping step, maximum power (e.g., Pcmax), and so forth.

A WTRU may determine, be configured, and/or indicated with one or more indications, conditions, and/or priority levels, based on which the WTRU may determine a valid RO to be used in case a first RO type and a second RO type overlap in time and/or frequency. In case a first type RO and a second type RO overlap in time and/or frequency, the WTRU may be configured and/or indicated to consider the first type RO as valid and the second type RO as invalid; the WTRU may consider the second type RO as valid and the first type RO as invalid; the WTRU may consider both first type and second type ROs as valid; the WTRU may consider both first type and second type ROs as invalid, and so forth.

Embodiments for selecting one or more RACH Occasions (ROs) are disclosed. The ROs may be selected from a set of configured ROs, based on one or more conditions. A WTRU may determine, be configured and/or preconfigured, and/or received an indication with one or more mapping rules between one or more reference signals (RS) (e.g., SSB index, CSI resource index, CSI resource set index, etc.). Herein, the solutions provided in this disclosure may be applied for selection of one or more, for example UL and/or DL occasions, for example for transmission and/or reception, out of a subset of different types of (e.g., UL/DL) occasions that may be determined in association with one or more configured mapping rules. The solutions may be used for determining RS-to-RO mapping for PRACH preamble (e.g., Msg1) transmission. The solutions may also be used for determining PUSCH Occasions (PO) in RS-to-PO mapping for random access PUSCH (e.g., Msg A) transmission. The solutions may also be used for determining PUSCH Occasions for mapping a number of valid PUSCH occasions for PUSCH transmissions over an association period, for example for configured grant Type 1 PUSCH transmissions on the initial UL BWP (e.g., for Small Data Transmission (SDT)), and so forth.

Hrein, the resource selection may comprise RO selection. However the solutions and examples in the disclosure may equally or equivalently or extendedly, etc. be employed (e.g., applicable) for cases with other resource selection types (e.g., PO, SDT, etc.).

A WTRU may determine, be configured, and/or indicated with the RS-to-RO mapping cycle, where the WTRU may be configured and/or receive configuration information on the RS-to-RO mapping rules. For example, the WTRU may be configured with the total number of RSs to be used for random-access procedure and the number of RSs associated with each RO. In an example, based on the configured ROs, the WTRU may be configured to map the RSs to valid ROs, first, in increasing order of preamble indexes within a single PRACH occasion, second, in increasing order of frequency resource indexes for frequency multiplexed PRACH occasions, third, in increasing order of time resource indexes for time multiplexed PRACH occasions within a PRACH slot, fourth, in increasing order of indexes for PRACH slots, and so forth.

In summary, a WTRU may select an RS resource or an RS block, for example from the total configured RSs and/or RS blocks. The WTRU may select the RO type, for example based on the mode of operation, for which the WTRU may receive and/or be configured with RACH configurations. The WTRU uses the configured RACH configurations for determining the RS-to-RO mapping and the ROs that are associated with the selected RS and/or RS block. The WTRU selects an RO that is associated with the selected RS and transmits PRACH preamble on the selected RO.

Several modes of operation and RO selection methods are provided herein.

A mode of operation may be UL/DL decoupling. A WTRU may receive one or more configuration information and/or indications on whether a same spatial filter, QCL relation, and/or TCI-state may be used for DL reception and UL transmission. For example, the WTRU may receive the configurations and/or indications via RRC, MAC-CE, DCI, SIB, etc. Additionally, or alternatively, the WTRU may receive the configurations and/or indications via in the information bits received as part of an RS block. The WTRU may receive the indication based on explicit indication and/or implicit indication.

In embodiments where there is explicit indication, the WTRU may receive a flag indication, where a first value may indicate that the same spatial filter (e.g., TCI state, QCL relation, etc.) can be used for UL transmissions and DL receptions, that is, for example beam correspondence may be considered. Additionally, a second value may indicate that the spatial filters used for UL transmissions and DL receptions may be different, that is, for example UL/DL decoupling may be considered.

In embodiments where there is implicit indication, the WTRU may (e.g., implicitly) determine the decoupled UL/DL with respect to spatial filter based on one or more configurations, indications, conditions, etc. In an example, if joint TCI state is used and/or configured for both DL and UL, the WTRU may determine to consider beam correspondence for the UL and DL. If separate TCI state for DL and UL is used, configured, and/or indicated, then the WTRU may consider decoupled UL and DL with respect to spatial filter.

The WTRU be configured with multi-carrier operation, where the WTRU may receive indications on whether cross-carrier beam correspondence can be considered. The WTRU may receive indications that the spatial filters used in different carriers may be different. The WTRU may receive a bitmap, where each bit may correspond to a configured carrier, in which a first value in each bit may indicate the carriers with beam correspondence and a second value may indicate the carriers with no beam correspondence. In such cases, if the WTRU is configured with UL in a first (e.g., UL) carrier and DL in a second (e.g., DL) carrier, and if the WTRU is indicated that there is no cross-carrier beam correspondence for the first and the second carriers, the WTRU may determine to consider the UL and DL to be decoupled with respect to the spatial filter.

The WTRU may determine the RO type to be used for random access operation, in addition to one or more corresponding parameters and/or configurations, based on the indication on UL/DL decoupling. For example, the WTRU may operate based on a first mode of operation if the UL and DL are configured as decoupled with respect to the UL and DL spatial filter; the WTRU may operate based on a second mode of operation if the UL and DL are configured as coupled (e.g., with beam correspondence) with respect to the UL and DL spatial filters. The WTRU may determine the mode of operation for DL and UL, jointly or separately, based on the indication on UL/DL decoupling.

In the first mode of operation, the WTRU may use a first RO type and the corresponding first RACH configurations for random-access operation. For example, the first RO type may indicate the first (e.g., UL) carrier and/or first (e.g., UL) BWP to be used for PRACH preamble transmission.

In the first mode of operation, the WTRU may determine the spatial filters for UL and DL, separately. For example, the WTRU may use a first QCL relation and/or TCI-state for DL and a second QCL relation and/or TCI-state for UL. The WTRU that is configured with a first and a second associated RSs may receive configuration information and/or indications on using the associated RSs based on the determined mode of operation. In another example, the WTRU that is configured with an RS block including a first and a second associated RSs may receive configuration information and/or indications on using the associated RSs based on the determined mode of operation. For example, in the first mode of operation, the WTRU may determine, be configured, preconfigured, and/or indicated to use the first RS as the reference RS for the first QCL-relation with the first TCI-state for DL reception, the second RS as the reference RS for the second QCL-relation with the second TCI-state for UL transmission, and/or the like.

The WTRU may measure the RSRP. The WTRU may select an RS based on one or more measured and/or evaluated parameters (e.g., the first RS with the highest measured RSRP). The WTRU may use the spatial filter for DL reception based on the selected first RS. The WTRU may use the first RS as the reference for the TCI-state for receiving the random-access response (RAR) (e.g., PDCCH, PDSCH, etc.). The WTRU may measure the RSRP and/or the pathloss based on the second RS that may be associated with the selected first RS. The WTRU may use the spatial filter that is determined for the second RS for UL transmission. The WTRU may use the second RS as the reference for the TCI-state for PRACH preamble transmission, PUSCH transmission (e.g., Msg B), Msg3 transmission, and so forth. The WTRU may use the determined pathloss for determining the PRACH UL power for PRACH preamble transmission.

The WTRU that has determined the valid ROs and the RS-to-RO mapping based on the first RO type configuration, may select the RO for PRACH preamble transmission. The WTRU may be configured to select the RO based on mapping the selected first RS's index. The WTRU may be configured to select the RO based on mapping the second RS's index. The WTRU may be configured to select the RO based on mapping the RS blocks'index, if configured. The WTRU may transmit PRACH preamble in the selected RO. The WTRU may monitor to receive RAR within the configured window. The WTRU may be configured to report one or more information regarding the measured first RS, for example first RS index, RSRP, etc., for example as part of Msg3. The WTRU may receive (e.g., CSI) report configurations after connecting to the cell to report one or more information regarding the measured first RS, for example first RS index, RSRP, etc.

A WTRU may be configured with one or more RSs, where there may be a one-to-many association between the configured RSs. The WTRU may be configured with an RS block where the RS block may include one or more first RSs and more than one second RSs that may be associated with a first RS. The WTRU may be configured to use the first RS as the reference for the DL TCI state, where the WTRU may use the second RSs as the reference for the UL TCI-states. The WTRU may measure one or more quality parameters based on the second RSs and the WTRU may select a second RS (e.g., the RS with the highest RSRP) to be used for determining the UL spatial filter for one or more UL transmissions. The WTRU may measure and/or evaluate the pathloss based on the selected second RS. The WTRU may determine the PRACH UL power based on the determined pathloss. The WTRU may send the PRACH preamble in the RO(s) associated with the selected second RS, based on the UL TCI-state determined based on the selected second RS, and according to the determined PRACH UL power. The WTRU may be configured to transmit the PRACH preamble in the RO associated with the first RS index and/or the RS block index. The WTRU may use one or more indications for indicating the selected second RS. One or more of the following may apply: implicit indication and/or explicit indication.

In embodiments where the WTRU uses implicit indication, the WTRU may use preamble partitioning. For example, the WTRU may select and transmit the PRACH preamble from a first set of preambles, if the WTRU selected a first RS from the second RSs; the WTRU may select and transmit the PRACH preamble from a second set of preambles, if the WTRU selected a second RS from the second RSs; and so forth.

In embodiments where the WTRU uses explicit indication, the WTRU may indicate the selected second RS as part of Msg3 and/or MsgA PUSCH indication. The WTRU may indicate the selected RS resource index. Additionally, or alternatively, the WTRU may receive (e.g., CSI) report configurations after connecting to the cell to report the selected second RS and the corresponding measurements, for example RS index, RSRP, etc.

A WTRU that may be performing random-access procedure based on a first RO type may determine to fallback to use a determined, configured, preconfigured, and/or indicated second RO type for random-access procedure in case the random-access based on the first RO type fails. For example, the WTRU may consider a random-access as failed if no RAR is received, even after retransmitting the PRACH preamble for the configured number of repetitions and re-attempting the PRACH preamble transmission with power ramping to the maximum configured number of times.

The second RO type may be configured based on a separate set of RACH configurations, for example in a different UL carrier, in a full-duplex carrier, in a carrier with subband non-overlapping full duplex (SBFD) operation, etc. Based on the second RO type, the WTRU may be configured with a second number of repetitions that may be greater than the first number of repetitions; the WTRU may be configured with a second threshold value for determining the number of repetitions that may be lower than the first threshold value; the WTRU may be configured with a second maximum value for the power ramping counter that may be higher than the first maximum value; and so forth.

The WTRU may determine the second RO type based on the first set of RACH configurations in addition to one or more offset values and/or threshold values. The WTRU may be configured with one or more offset values to determine the second number of repetitions, second threshold value, second maximum value, etc. based on the configured first RACH configurations. The WTRU may be configured with one or more offset values for determining the time and/or frequency resources for the second type ROs, based on the configured first RACH configurations.

In the second mode of operation, the WTRU may use a third RO type and the corresponding third RACH configurations for random-access operation. The WTRU may determine and use a spatial filter for UL and DL jointly. The WTRU may select a first RS and determine the UL/DL spatial filter based on the selected first RS. The WTRU may transmit the PRACH preamble using the determined spatial filter, based on an RO that is determined according to the third RO type that is associated with the first selected RS. The WTRU may monitor for RAR based on the determined spatial filter and send and receive further UL and DL messages (e.g., Msg3, MsgB, Msg4, etc.) based on the determined spatial filter.

The mode of operation may be RS decoupling. A WTRU that is configured with RS decoupling may determine the RO types to be used for PRACH preamble transmission in the random-access procedure based on mode of operation. The WTRU may be configured with RS decoupling, where the WTRU may determine, be configured, and/or indicated to use a first set of RSs, for example for random-access operation, if the WTRU is operating based on a first mode of operation. The WTRU may use a second set of RSs, if the WTRU is operating based on a second mode of operation. The mode of operation may be based on RRC states, where the first mode of operation may be for WTRU being in RRC-Idle or RRC-Inactive mode, and the second mode of operation may be based on WTRU being in RRC-Connected mode.

The WTRU may be configured with a first and a second RO types and the corresponding configuration information. The WTRU may use the first RO type if the WTRU is operating in the first mode of operation. For example, the first RO type may correspond to the ROs in a first carrier and/or a first BWP (e.g., initial BWP). The WTRU may use the second RO type in case the WTRU is operating in the second mode of operation. For example, the second RO type may correspond to the ROs in a second carrier and/or a second BWP (e.g., active BWP).

A WTRU that is configured with a first and a second associated RSs may determine, be configured, preconfigured, and/or indicated to use the associated RSs based on the determined mode of operation. The WTRU that is configured with an RS block including a first and a second associated RSs may determine, be configured, preconfigured, and/or indicated to use the associated RSs based on the determined mode of operation. For example, in the first mode of operation, the WTRU may be configured to use the first RS, and/or in the second mode of operation, the WTRU may use the second RS.

The WTRU may use the first or the second RSs for measuring one or more quality parameters (e.g., RRM measurements, RSRP, RSSI, etc.). The only or more quality parameters may be used for determining the spatial filter for transmission, reception, for determining the reference RS for the QCL relation with a corresponding TCI state, for determining the pathloss for determining the (e.g., PRACH) UL power, and/or the like.

During the random-access procedure, the WTRU selects a first or second RS. The WTRU selects the first or second RS based on the mode of operation (e.g., with highest RSRP). The WTRU measures RSRP and determines pathloss. The WTRU determines the RO type based on the mode of the operation and selects an RO based on the selected RS. The WTRU transmits PRACH preamble based on the selected RO, the determined spatial filter, and the determined PRACH UL power. The WTRU monitors to receive RAR within the configured time window.

The WTRU may receive the second PRACH configuration information regarding the second RO type separately from the first PRACH configurations corresponding to the first RO type. The WTRU may receive one or more delta values, offset values, and/or scaling factors, based on which, the WTRU may determine the second set of PRACH configurations based on the configured first set of PRACH configurations.

A WTRU that is operating based on a second mode of operation may determine that the random-access operation based on the second RO type and the second RS has failed. As such, the WTRU may fall back to use the first RS and the first type RO for the random-access procedure. For example, the WTRU may consider a random-access as failed if no RAR is received, even after retransmitting the PRACH preamble for the configured number of repetitions and re-attempting the PRACH preamble transmission with power ramping to the maximum configured number of times.

A mode of operation may be service and/or device types. A WTRU may receive a set of different RS transmissions, for example within an RS block. The WTRU may determine, be configured, preconfigured, and/or be indicated with an association between an RS (e.g., the first RS and/or second RS in a received RS block), and a service type and/or a WTRU device type, capability, category and/or status.

A service type may entail service type, service type requirement, service type provide, service geographical area. An RS may be associated with a service type (e.g., Enhanced Mobile Broadband (eMBB), Ultra Reliable and Low Latency Communications (URLLC), Internet of Things (IoT), and/or Industrial Internet of Things (IIoT)). An RS may be associated with one or more requirements for a service type (e.g., data throughput, latency, reliability, coverage). An RS may be associated with a service type provider identity (e.g. cell-ID, Public Land Mobile Network (PLMN)-ID). An RS may be associated with a geographical area supported for a service type (e.g., TRP-ID, cell-ID, PLMN-ID, zone-ID).

A WTRU device type may entail device type, device capability, device category and/or device status. An RS may be associated with device type of a WTRU (e.g., Fixed Wireless Access (FWA) WTRU, vehicular WTRU, handheld WTRU, Reduced Capability (RedCap) WTRU, Low Power Wide Area (LPWA) WTRU, Wearable WTRU. An RS may be associated with one or more following WTRU capabilities related to hardware and/or software implementation: number of transmit and/or receive antenna, number of radio transceiver chain, supported channel frequency bandwidth, supported combination of frequency band and/or carriers, beamforming capability, supported sub-carrier spacing and associated Fast Fourier Transform (FFT) size, maximum number of downlink control channel blind decoding, maximum supported transport block size, maximum transmit power, minimum receiver sensitivity, maximum time and frequency synchronization error, and/or number of supported WTRU features. An RS may be associated with a WTRU category defined and/or predefined based on the forementioned WTRU type and/or capabilities. An RS may be associated with one or more of the following WTRU device status: power saving state, remaining battery level, device temperature, WTRU speed, and/or WTRU location.

The association between an RS (e.g., in an RS block) and service and/or WTRU device type may be indicated in a channel transmitted in the same RS and/or RS block. One or more RS association indication fields may be included (e.g. in a bit map) in a PBCH (e.g., in an SSB). Each indication field may consist of a configured and/or preconfigured number of bits and correspond to a transmitted RS (e.g., in the RS block). The code point may indicate one or more of the service type and/or device type associated with the corresponding RS.

A WTRU may be configured and/or preconfigured with an association between an RS (e.g., in an RS block) and service and/or device type specific to one or more of the following: a carrier, Global Synchronization Channel Number (GSCN) and/or sync raster, and/or RS block type.

A carrier, GSCN, an RS, and/or an RS block type may be configured and/or preconfigured with a service and/or device type associated with each RS (e.g., in an RS block) type transmitted at the GSCN within a carrier. A carrier and/or a GSCN within a carrier may be configured and/or preconfigured with an RS and/or an RS block type including two RS transmissions with the first associated with reduced capability WTRU (e.g., RedCap WTRU, LPWA WTRU, IoT WTRU) and the second with advanced WTRUs (e.g. FWA WTRU, vehicular WTRU, handheld WTRU). A carrier and/or a GSCN within a carrier may be configured and/or preconfigured with an RS and/or an RS block type including two RS transmissions with the first associated with IoT service and the second with eMBB service.

The WTRU may be configured and/or preconfigured to determine an RS (e.g., from an RS block), as a reference RS. A WTRU may select a first RS or second RS (e.g., from an RS block), based on the above-discussed association of the first and second RS transmission and the service and/or device type of the WTRU.

A WTRU may receive one or more associated RSs and/or an RS block with first RS associated with reduced capability device type and second RS associated with advanced device type. The first RS may be associated with IoT service type and second RS may bw associated with eMBB service type.

A WTRU with reduced capability may determine to select an RS (e.g. the first RS in the RS block) associated with the device type of LPWA, RedCap, and/or IoT WTRU. A WTRU performing IoT service (e.g. sensor and meter applications) may select an RS (e.g. the first RS in the RS block) associated with the IoT service type. The first RS may be transmitted in a wide beam, within a limited frequency resource allocation (e.g., 3 RBs, 6 RBs and/or 12 RBs), over an extended period of transmission duration (e.g., 7 symbols, 14 symbols), and/or with large number of repetitions. The RS transmission may reduce WTRU processing and battery consumption and optimize for further data application with small payload and long delay.

A WTRU with advanced capability may determine to select an RS (e.g. the second RS in the RS block) associated with the device type of FWA WTRU, vehicular WTRU, and/or handheld WTRU. A WTRU performing eMBB service (e.g. Extended Reality (XR) and video streaming application) may select an RS (e.g. the second RS in the RS block) associated with the eMBB service type. The second RS may be transmitted in a narrow beam with high beamforming gain, within a large frequency resource allocation (e.g., 20 RBs), over a short period of transmission duration (e.g., 2 symbols, 4 symbols), and/or with limited number of repetitions. The RS transmission may optimize for high data throughput and low latency performance.

A WTRU may determine its own geographic location information based on WTRU's GNSS information, zone ID and/or camping cell and/or TRP location information. A WTRU may select an RS associated with the determined WTRU geographic information.

An RS may be associated with reduced capability device type and WTRU power saving state for all device types. For example, a WTRU with advanced capability in power saving state may select the first RS associated with reduced capability device type. When the WTRU may exit the power-saving state, the WTRU may re-select the second RS associated with advance capability device type as reference RS.

A WTRU may receive a multitude of RS blocks including the selected reference RS transmission. In one example, a WTRU may combine the received reference RS transmissions from the RS blocks and determine a reference RS RSRP. A WTRU may select an RS block as a reference RS block including the reference RS transmission of highest RSRP.

A WTRU may identify a determined reference RS as RS index and/or RS Resource Indication (RI).

An RS may be configured, preconfigured, and/or indicated with an RS index. The RS index may be the index of the sequence used for the RS transmission. The RS index may be configured and/or preconfigured.

A WTRU may identify an RS using the time and/or frequency resource in which the RS may be transmitted. A WTRU may determine an identity of a SSB, CSI-RS, mobility RS, and/or TRS using SSB-RI, CSI-RS-RI, Measurement Reference Signal (MRS)-RI, and/or Tracking Reference Signal (TRS)-RI, respectively.

A WTRU may determine to perform one or more of the following based on the determined reference RS (e.g., in an RS block). The WTRU may perform one or more of the following according to a set of configurations and/or pre-configurations associated with and/or indicated by the identity of the determined reference RS: carrier selection; timing and frequency synchronization; Tx and Rx beam and/or spatial filter determination; DL control channel resource determination and decoding; user plane (UP) control information transmission; TCI state reference indication; pathloss estimation; RACH transmission determination including RACH occasion; preamble power; preamble sequence selection; preamble repetition; preamble frequency hopping, etc. ; and/or the like.

A WTRU may be configured and/or preconfigured with a default, base and/or fallback operation mode associated with a reference RS (e.g., in an RS block). The reference RS may be a first RS associated with reduced capability WTRU, IoT service type, and/or power saving state. When a WTRU may select a first RS as a reference RS, the WTRU may perform one or more of the following according to a set of configurations and/or pre-configurations associated with and/or indicated by the first RS in the RS block:
(i) A WTRU may select a first, default, base and/or fallback carrier (e.g. in FR1) for cell access.
(ii) A WTRU may perform time and frequency synchronization based on one or more SSBs transmitted in the selected carrier. The SSBs may be transmitted with reduced bandwidth (e.g. 3 MHz) and extended time-duration (e.g. 14 symbols).
(iii) A WTRU may transmit and/or receive in wide beam.
(iv) A WTRU may monitor and decode DL control channel in resources (e.g. CORESET) with reduced bandwidth (e.g. 3 RBs). A WTRU may be configured and/or preconfigured with a sparse monitoring pattern and large monitoring interval.
(v) A WTRU may apply a first set of data parameters, for example for the user plane, control plane, SRB (Signaling Radio Bearer), DRB (Data Radio Bearer), and/or LCH (Logical Channel), including a low priority level (e.g., LCH priority or L1 priority), low QoS requirements, long delay budget, low required reliability, reduced HARQ codebook sizes, etc.
(vi) A WTRU may apply the first RS as TCI state for QCL relationship indication for PDCCH, PDSCH, PRACH, PUSCH, and/or PUCCH transmission.
(vii) A WTRU may estimate a path loss based on the measured RSRP of the first RS transmission and/or the first RS transmit power (e.g., indicated in the RS block). A WTRU may determine an UL transmit power (e.g. preamble, PUCCH and/or PUSCH power) based on the determined path loss.
(viii) A WTRU may select RACH occasions (ROs) configured and/or preconfigured in the first carrier associated with the first RS. A WTRU may be configured and/or preconfigured with an RO pattern for preamble transmission and/or repetition associated with the first RS. A WTRU may determine a Tx beam for the preamble transmission at an associated RO based on the spatial filter configuration used to receive the first RS (e.g., preamble transmission) using a TCI state indicated based on the first RS. The first RS may be configured and/or preconfigured with a frequency hopping pattern within the associated RO pattern. The frequency resource for preamble format associated with the first RS may be based on the number of sub-carriers.

A WTRU may select a second RS as the reference RS associated with advanced capability WTRU, eMBB service type and/or non-power saving state. When a WTRU may select a second RS as a reference RS, the WTRU may perform one or more of the following according to a set of (pre)configurations associated with and/or indicated by the second RS in the RS block:
(i) A WTRU may select a second carrier (e.g. in FR2) for cell access.
(ii) A WTRU may perform time and frequency synchronization based on one or more SSBs transmitted in the selected carrier. The SSBs may be transmitted with a large bandwidth (e.g. 20 RBs) and within a reduced time-duration (e.g. 4 symbols).
(iii) A WTRU may transmit and/or receive in narrow beam.
(iv) A WTRU may monitor and decode DL control channel in resources (e.g. CORESET) with large bandwidth (e.g. 24 RBs). A WTRU may be configured and/or preconfigured with a frequent monitoring pattern and small monitoring interval.
(v) A WTRU may apply a second set of data parameters, for example for the user plane, control plane, Signaling Radio Bearer (SRB), Data Radio Bearer (DRB), and/or Logical Channel (LCH), including a high priority level (e.g., LCH priority or L1 priority), high QoS requirements, short delay budget, high required reliability, enhanced HARQ codebooks, etc.
(vi) A WTRU may apply the second RS as TCI state for QCL relationship indication for PDCCH, PUCCH, PRACH, PDSCH and PUSCH transmission.
(vii) A WTRU may estimate a path loss based on the measured RSRP of the second RS transmission and the second RS transmit power (e.g., indicated in the RS block). A WTRU may determine an UL transmit power (e.g. preamble, PUCCH and/or PUSCH power) based on the determined path loss and configured and/or preconfigured PRACH reference power offset.
(viii) A WTRU may select RACH occasions (ROs) configured and/or preconfigured in the second carrier associated with the second RS. A WTRU may be configured and/or preconfigured with an RO pattern for preamble transmission and/or repetition associated with the second RS. A WTRU may determine a Tx beam for the preamble transmission at an associated RO based on the spatial filter configuration used to receive the second RS (e.g., preamble transmission) using a TCI state indicated based on the second RS. The frequency resource for preamble format associated with the first RS may be based on the number of RBs.

A mode of operation may be RS burst type(s) (e.g., SSB burst type(s)). The WTRU may be configured and/or preconfigured with one or more of the following types of RSs: periodic RS (e.g., always-on (AO)-RS) and/or on-demand (OD) RS.

A periodic RS may be transmitted according to a configured and/or preconfigured periodicity. A WTRU may assume the RS transmission may be present at each configured and/or preconfigured periodical transmission occasion. For example, a WTRU may assume a periodic RS may be always-on RS (AO-RS). AO-RS may be transmitted with a low periodicity (i.e. with short intervals). A WTRU may be configured and/or preconfigured with an AO-RS block that may include one or more RSs of identical TCI state (e.g. transmitted in identical wide beam). A WTRU may be configured and/or preconfigured with an AO-RS block that may include one or more RSs of different TCI states. For example, the different TCI-states, may correspond to different wide beams in a wide beam sweeping, a TCI-state associated with a wide beam and at least one other TCI-state associated with a narrow beam, a TCI-state associated with a first beam and at least one other TCI-state associated with a second beam with a differential relation with the first beam, and so forth.

An On-demand RS (OD-RS) may be aperiodic and transmitted based on request (e.g. from one or more WTRUs). A WTRU may be configured and/or preconfigured with an OD-RS block including one or more AO-RS transmissions. An OD-RS block may include a first RS, a second RS, a third RS, and so forth. The OD-RS transmissions may be time multiplexed in consecutive symbols. The following embodiments may be described based on three OD-RSs in an OD-RS block and may apply to more OD-RSs and still consistent with the embodiments.

Herein, the association between the reference signals may comprise the OD-RSs. However, the embodiments and examples disclosed herein may equally (or equivalently or extendedly, etc.) be employed (e.g., applicable) for cases with other reference signals (e.g., AO-RS, SSB, CSI-RS, TRS, PT-RS, DM-RS, etc.).

A first OD-RS may be transmitted in a wide beam and indicate a QCL relation with a first TCI state (e.g., the first TCI state based on the first OD-RS). A second OD-RS may be transmitted in a narrow beam associated with the wide beam transmission of the first OD-RS. The association between the first and second OD-RS may be in the spatial domain (e.g. based on AoA and/or in the power domain, e.g. based on measured RSRP and/or RSSI).

The association between the first OD-RS and the second and/or third OD-RS may be based on AoA of the OD-RSs. A second OD-RS may be received in an AoA that may be a part of the AoA of the first OD-RS. A third RS may be received in an AoA that may be a different part of the AoA of the first OD-RS. The sum of AoA coverage of the second and third RS may equal to the AoA coverage of the first RS. A WTRU may determine a second TCI state based on the second OD-RS and third TCI state based on the third OD-RS. A WTRU may indicate a TCI state of the second OD-RS using the first OD-RS and a measured AoA difference between the first and second OD-RS. A WTRU may indicate a TCI state of the third OD-RS using the first OD-RS and a measured AoA difference between the first and third OD-RS.

The association between the first OD-RS and the second and/or third OD-RS may be based on RSRP of the received OD-RS. A WTRU may measure the RSRP of the first, second and third OD-RS in an OD-RS block. A WTRU may determine a second TCI state based on the second OD-RS and third TCI state based on the third OD-RS. A WTRU may indicate a TCI state of the second OD-RS using the first OD-RS and a measured RSRP difference and/or ratio between the first and second OD-RS. A WTRU may indicate a TCI state of the third OD-RS using the first OD-RS and a measured RSRP difference and/or ratio between the first and third OD-RS.

A WTRU may detect and receive a set of OD-RSs and/or OD RS blocks when the WTRU may send an OD-RS request to the network. OD-RS transmission configuration may be configured and/or preconfigured and include one or more of the following parameters: OD-RS time and frequency resource, OD-RS sequence, and/or OD-RS block transmission period.

The time and/or frequency resource may be indicated relative to the time and/or frequency of the OD-RS request transmission. The time and/or frequency may be configured and/or preconfigured in a System Frame Number (SFN), sub-frame, slot index and/or symbol index in time domain and sub-carrier and/or PRB index in frequency domain.

A WTRU may be configured and/or preconfigured with an OD-RS sequence associated with the one or more sequences used in the OD-RS request transmission. A fixed sequence may be configured and/or preconfigured.

The period in which one or more OD-RS blocks may be transmitted in response to an OD-RS request transmission may be configured, preconfigured, and/or determined (e.g., based on WTRU capability).

A WTRU may determine to select an OD-RS and/or an OD-RS block with the highest RSRP within the OD-RS transmission period as a reference OD-RS and/or OD-RS block. A WTRU may select the first OD-RS (e.g., in the reference OD-RS block), as a first reference OD-RS. The first reference OD-RS may be based on wide beam. A WTRU may perform one or more of the following in Random Access procedure based on the first reference OD-RS.

A WTRU may determine an RO based on configured and/or preconfigured association between the first reference OD-RS and RO(s) (OD-RO) in the cell. The OD-RO(s) may be configured and/or preconfigured within a time period associated with the OD-RS transmission period. The length of the OD-RO time period and the time offset relative to the OD-RS transmission period may be configured and/or preconfigured and/or indicated (e.g., via RRC, MAC-CE, DCI, SIB, in the OD-RS block, etc.).

A WTRU may select one of the second or third AO-RSs (e.g., in the reference AO-RS block, as a second reference AO-RS). The second and/or third AO-RS may be based on narrow beam and thus may be applied to increase PRACH transmission coverage. A WTRU may perform one or more of the following based on the second reference AO-RS:
(i) A WTRU may apply the second reference OD-RS as TCI state for QCL relationship indication for PRACH transmission. A WTRU may use a transmit beam corresponding to the receive beam used for the second reference OD-RS.
(ii) A WTRU may estimate a path loss based on the measured RSRP of the second reference OD-RS transmission and the second reference OD-RS transmit power (e.g., indicated in the OD-RS block). A WTRU may determine a PRACH transmit power based on the determined path loss and the configured and/or preconfigured PRACH reference power offset.
(iii) A WTRU may monitor and decode DL control channel in resources (e.g. RAR) in a CORESET associated with the reference AO-RS and/or the reference OD-RS block. The associated CORESET may be located with a time offset (e.g. symbols, slots, sub-frames, frames) relative to the reference AO-RS and/or reference OD-RS block and within the same frequency resource as the reference AO-RS and/or AO-RS block.
(iv) A WTRU may measure channel state information (CSI) on the second reference OD-RS transmission (e.g. L1-RSRP, CQI, L1-SINR). A WTRU may measure CSI information in CSI-RS transmission QCL-ed with the second reference OD-RS.
(v) A WTRU may report the measured CSI in a PUCCH and/or PUSCH scheduled in a received RAR. A WTRU may measure and report CSI of all OD-RSs (e.g., received in an OD-RS block).

A WTRU may not detect and receive an OD-RS and/or an OD-RS block within the configured and/or preconfigured OD-RS and/or OD-RS block transmission period when the WTRU may send an OD-RS request to the network. This may occur during, for example, beam failure recovery (BFR), Low-layer Triggered Mobility (LTM), etc. A WTRU may perform one or more of the following when the WTRU may not detect and receive OD-RS and/or OD-RS block in this case:
(i) A WTRU may perform additional request transmissions for OD-RS block. The maximum number of additional request transmission may be configured and/or preconfigured.
(ii) A WTRU may determine to transmit a PRACH based on AO-RS transmission, a fallback to reference AO-RS-based RACH when the WTRU may not detect and receive OD-RSs and/or OD-RS blocks in any OD-RS and/or OD-RS block transmission period associated with the performed request transmissions.
(iii) A WTRU may select an AO-RS with the highest measured RSRP as a reference AO-RS.
(iv) A WTRU may determine an RO based on configured and/or preconfigured association between the selected reference AO-RS and RO(s) (AO-RO(s)) in the cell. The AO-RO(s) may be configured and/or preconfigured within periodicity associated with the periodicity of the AO-RS and/or AO-RS block.
(v) A WTRU may apply the reference AO-RS as TCI state for QCL relation indication for PRACH transmission. A WTRU may use a transmit spatial filter and/or beam corresponding to the receive spatial filter and/or beam used for the reference AO-RS.
(vi) A WTRU may estimate a path loss based on the measured RSRP of the reference AO-RS transmission and the reference AO-RS transmit power (e.g., indicated in the AO-RS block). A WTRU may determine a PRACH transmit power based on the determined path loss and the configured and/or preconfigured PRACH reference power offset.

The WTRU may receive and/or be configured with one or more one-shot RS resources, RS blocks, RS block bursts, and/or RS resource bursts. For example, the one-shot RS resources may be configured based on aperiodic RS resources, RS blocks, RS block bursts, etc. The WTRU may receive one or more configuration information and/or indications on the RS bursts, for example via DCI, MAC-CE, RRC, SIB, as part of an RS block, etc. The configuration information may include (i) indication and/or activation of one-shot RS bursts and/or (ii) RACH Association Configurations.

A WTRU may receive one or more indications on one or more aperiodic and/or one-shot RS bursts. The indications may include the starting time, time offset, frequency resources, power settings, number of RSs in the RS burst, etc. with regards to one or more one-shot and/or aperiodic RS bursts. The WTRU may receive the indications via DCI, MAC-CE, RRC, SIB, etc. The WTRU may receive and/or be configured and/or preconfigured (e.g., via RRC, SIB, etc.) with a set of one or more aperiodic and/or one-shot RS bursts, where the configurations may include an index to the configured aperiodic and/or one-shot RS burst. The WTRU may then receive an activation indication (e.g., dynamic), for example via DCI, MAC-CE, etc., indicating the aperiodic and/or one-shot RS burst that may be activated. The activation indication may include the index to the configuration information to be activated and/or used. The activation indication may include one or more configuration information (e.g., starting time, time offset, frequency resources, etc.) with respect to the received activation indication. The WTRU may receive the activation indication via DCI, MAC-CE, etc.

The WTRU may determine the RACH association period for the aperiodic and/or one-shot RS bursts based on one or more determined, indicated, and/or configured parameters and/or configuration information. The WTRU may determine, be indicated, and/or configured to consider the RACH association period for the aperiodic RS bursts, starting from a determined, indicated, and/or configured time instance. The WTRU may be configured with an offset value, based on which the WTRU may determine the starting time instance (e.g., symbol, slot, frame, etc.) for the RACH association period with respect to one or more reference time instances. For example, the reference time may be based on the beginning of the aperiodic RS and/or RS bursts transmission. In another example, the reference time may be based on the time that the activation indication on the aperiodic RS burst transmission was received (e.g., via MAC-CE, DCI, etc.). The WTRU may be configured and/or preconfigured with and/or receive configuration information on the starting time for the RACH association period for aperiodic RSs and/or RS bursts. The WTRU may receive the configuration information as part of the received indication and/or activation signaling on the aperiodic and/or one-shot RS and/or RS burst transmission (e.g., via MAC-CE, DCI, etc.). The WTRU may consider the RACH association period for mapping RS and/or RS block indexes to ROs, as the smallest integer number in the set, for example determined by the PRACH configuration period, such that the RS and/or RS block indexes are mapped at least once to the ROs within the association period.

A mode of operation may be coverage. The WTRU may be configured to monitor one or multiple RSs and/or RS blocks, where each RS block includes multiple RSs. For example, the WTRU may be configured to monitor two RS blocks, where the first RS block includes a first RS with a first beam direction and a second RS with a second beam direction. The second RS block includes a third RS with a third beam direction and a fourth RS with a fourth beam direction. The WTRU may determine its coverage conditions by measuring the one or more received RSs. Depending on the WTRU's coverage conditions, the WTRU selects RS block and/or one or more RSs (e.g., within an RS block). The WTRU then determines the RACH Occasion and the PRACH preamble for RACH procedure based on the selected RS(s) and/or RS block.

The WTRU may determine its coverage conditions based on measuring RSRP of RS(s) (e.g., within RS block(s)). The WTRU determines bad coverage conditions when the measured RSRP of all detected RS(s) (e.g., in all RS blocks) are below a configured threshold. The WTRU determines good coverage conditions when the measured RSRP of at least one detected RS(s) (e.g., within the RS block(s)), is above a configured threshold. The WTRU may determine bad coverage conditions when the accumulated RSRP of all RS(s) (e.g., within RS block), are below a configured threshold.

The WTRU may be configured to select an RS block and/or an RS (e.g., within the RS block) after determining the coverage conditions. In some solutions, when the WTRU determines bad coverage conditions, the WTRU combines the measurements based on all the RSs (e.g., of an RS block), and the WTRU selects one RS and/or RS block from multiple RSs and/or RS blocks. When the WTRU determines good coverage conditions, the WTRU may select one RS from multiple RSs, e.g., belonging to the same RS block. The WTRU may start by selecting an RS block and then select an RS from the selected RS block. For example, the gNB may use two different beams to transmit two RSs (e.g., in the same RS block). The WTRU may select the RS (e.g., from RS block) with higher RSRP.

In an example, a WTRU may select an RS block from multiple RS blocks based on one or more of the following:
(i) Accumulated RSRP of all the RSs within the RS block. For example, the WTRU may select an RS block that has the highest accumulated RSRP of RSs within the RS block.
(ii) Average RSRP of the RSs within the RS block. For example, the WTRU may select an RS block that has the highest average RSRP of RSs.
(iii) The smallest RSRP of all the RS within the RS block. For example, the WTRU may select an RS block that has the smallest RSRP of all RSs that is above a configured threshold.

The WTRU may select an RS from multiple associated RSs, e.g., within the same RS block, based on one or a combination of the following:
(i) RSRP of the RS. For example, the WTRU may select the RS with the highest RSRP among the associated RSs, e.g., within an RS block.
(ii) Beam direction of the RS. For example, the WTRU may select the RS that has the beam direction aligned with the WTRU's uplink beam. That is, the WTRU may select the RS that has the similar and/or correlated spatial filter with the WTRU's uplink spatial filter.

The WTRU may perform random access after selecting RS and/or RS block. The WTRU may be configured with a first set of RACH configurations and a second set of RACH configurations. The WTRU may be configured to perform random access based on the first set of RACH configurations, if the WTRU is operating based on a first mode of operation, for example, in case the WTRU is in good coverage. The WTRU may be configured to perform random access based on the second set of RACH configurations if the WTRU is operating based on a second mode of operation, for example, in case the WTRU is in bad coverage.

The WTRU may select a RO and a PRACH resource within RO for random access procedure based on the configured first or second RACH configurations and the selected RS and/or RS block. The WTRU may be configured with an association between an RS and/or an RS block and a sub-set of RACH occasions and/or PRACH preambles. When the WTRU selects an RS and/or an RS block, the WTRU may select an RO as well as PRACH preamble according to the configured association.

A WTRU in a good coverage may determine to fall back to measure the RSs and perform the random-access based on the procedures configured to be used for WTRUs in bad coverage, based on one or more conditions and/or events. The WTRU in a good coverage that has selected a first RS, may perform random-access based on a first set of RACH configurations, e.g., good coverage RACH configurations. The WTRU may determine to fall back in case the random-access has failed. The WTRU may consider random-access as failed, in case the WTRU does not receive RAR after power ramping and PRACH preamble re-transmissions up to a determined, configured, and/or indicated maximum number of re-attempts.

Due to the fall back, the WTRU may select a second RS (e.g., based on bad coverage procedure), for example by combining measurements based on all associated RSs (e.g., in an RS block). The WTRU may perform random access procedure based on a second set of RACH configurations (e.g., bad coverage RACH configurations).

1. A Wireless Transmit/Receive Unit (WTRU) comprising:
a processor configured to:
receive a first reference signal and a second reference signal, wherein the first reference signal and the second reference signal are associated, and wherein the first reference signal is associated with a first beam direction and the second reference signal is associated with a second beam direction;
receive a first Random Access Channel (RACH) configuration associated with the first reference signal and a first set of RACH occasions, and a second RACH configuration associated with the second reference signal and a second set of RACH occasions;
select a RACH occasion for an uplink transmission, wherein the RACH occasion is selected from the first set of RACH occasions when the WTRU is in a Radio Resource Control (RRC) idle state, and wherein the RACH occasion is selected from the second set of RACH occasions when the WTRU is in an RRC connected state; and
send the uplink transmission via the selected RACH occasion.

2. The WTRU of claim 1, wherein the processor is configured to:
select the RACH occasion from the first set of RACH occasions based on an index associated with the first reference signal when the WTRU is in the RRC idle state, and select the RACH occasion from the second set of RACH occasions based on an index associated with the second reference signal when the WTRU is in the RRC connected state.

3. The WTRU of claim 1, wherein the uplink transmission comprises a Physical Random-Access Channel (PRACH) preamble.

4. The WTRU of claim 1, wherein the first RACH configuration indicates a first set of RACH parameters, and wherein the second RACH configuration indicates a second set of RACH parameters; and
wherein the processor is configured to select RACH parameters for sending the uplink transmission, wherein the RACH parameters are the first set of RACH parameters when the WTRU is in the RRC idle state and the RACH parameters are the second set of RACH parameters when the WTRU is in the RRC connected state.

5. The WTRU of claim 4, wherein the selected RACH parameters include at least one of time and frequency resources, association period, RACH Occasion Component Carrier, or RACH Occasion BWP.

6. The WTRU of claim 1, wherein the first reference signal and the second reference signal are associated with a reference signal block.

7. The WTRU of claim 6, wherein the processor is configured to:
receive a plurality of reference signal blocks, wherein the plurality of reference signal blocks comprise the reference signal block; and
select the reference signal block based on a signal measurement associated with the reference signal block.

8. The WTRU of claim 6, wherein the reference signal block comprises a synchronization signal block (SSB), wherein the first reference signal comprises a first secondary synchronization signal (SSS), and wherein the second reference signal comprises a second SSS.

9. The WTRU of claim 1, wherein the first reference signal is associated with a wide beam and the second reference signal is associated with at least one of a differential beam or a narrow beam.

10. A method implemented by a Wireless Transmit/Receive Unit (WTRU), the method comprising:
receiving a first reference signal and a second reference signal, wherein the first reference signal and the second reference signal are associated, and wherein the first reference signal is associated with a first beam direction and the second reference signal is associated with a second beam direction;
receiving a first Random Access Channel (RACH) configuration associated with the first reference signal and a first set of RACH occasions, and a second RACH configuration associated with the second reference signal and a second set of RACH occasions;
selecting a RACH occasion for an uplink transmission, wherein the RACH occasion is selected from the first set of RACH occasions when the WTRU is in a Radio Resource Control (RRC) idle state, and wherein the RACH occasion is selected from the second set of RACH occasions when the WTRU is in an RRC connected state; and
sending the uplink transmission via the selected RACH occasion.

11. The method of claim 10, further comprising:
selecting the RACH occasion from the first set of RACH occasions based on an index associated with the first reference signal when the WTRU is in the RRC idle state or selecting the RACH occasion from the second set of RACH occasions based on an index associated with the second reference signal when the WTRU is in the RRC connected state.

12. The method of claim 10, wherein the uplink transmission comprises a Physical Random-Access Channel (PRACH) preamble.

13. The method of claim 10, wherein the first RACH configuration indicates a first set of RACH parameters, and wherein the second RACH configuration indicates a second set of RACH parameters; and
the method further comprising selecting RACH parameters for sending the uplink transmission, wherein the RACH parameters are the first set of RACH parameters when the WTRU is in the RRC idle state and the RACH parameters are the second set of RACH parameters when the WTRU is in the RRC connected state.

14. The method of claim 13, wherein the selected RACH parameters include at least one of time and frequency resources, association period, RACH Occasion Component Carrier, or RACH Occasion BWP.

15. The method of claim 10, wherein the first reference signal and the second reference signal are associated with a reference signal block.

16. The method of claim 15, further comprising:
receiving a plurality of reference signal blocks, wherein the plurality of reference signal blocks comprise the reference signal block; and
selecting the reference signal block based on a signal measurement associated with the reference signal block.

17. The method of claim 15, wherein the reference signal block comprises a synchronization signal block (SSB), wherein the first reference signal comprises a first secondary synchronization signal (SSS), and wherein the second reference signal comprises a second SSS.

18. The method of claim 10, wherein the first reference signal is associated with a wide beam and the second reference signal is associated with at least one of a differential beam or a narrow beam.

19. A Wireless Transmit/Receive Unit (WTRU) comprising:
a processor configured to:
receive a first reference signal and a second reference signal, wherein the first reference signal and the second reference signal are associated, and wherein the first reference signal is associated with a first beam direction and the second reference signal is associated with a second beam direction;
receive an indication of a first Random Access Channel (RACH) occasion associated with a first mode of operation and the first reference signal, and a second RACH occasion associated with a second mode of operation and the second reference signal;
select a RACH occasion for a Physical Random-Access Channel (PRACH) preamble transmission, wherein the first RACH occasion is selected when the WTRU is in the first mode of operation, and the second RACH occasion is selected when the WTRU is in the second mode of operation; and
send the PRACH preamble transmission via the selected RACH occasion.

20. The WTRU of claim 19, wherein the first mode of operation of the WTRU comprises at least one of being in an Radio Resource Control (RRC) idle state, uplink and downlink being decoupled with respect to an uplink and downlink spatial filter, one or more WTRU capabilities not meeting a threshold, one or more coverage conditions not meeting a threshold, or using on-demand reference signal burst type, and
wherein the second mode of operation of the WTRU comprises at least one of being in an RRC connected state, uplink and downlink being coupled with respect to the uplink and downlink spatial filter, one or more WTRU capabilities exceeding a threshold, one or more coverage conditions exceeding a threshold, or using always on reference signal burst type.
